(19) United States
(12) Patent Application Publication
(10) Pub. No.: US 2023/0169356 A1
(43) Pub. Date: Jun. 1, 2023

(54) Communications System, First Node, Second Node, Third Node and Methods Performed Thereby for Handling a Prediction of an Event

(71) Applicant: Telefonaktiebolaget LM Ericsson (publ), Stockholm (SE)

(72) Inventors: Arindam Banerjee, Howrah (IN); Saravanan Mohan, Chennai (IN)

(21) Appl. No.: 17/912,994

(22) PCT Filed: Apr. 3, 2020
(86) PCT No.: PCT/IN2020/050325

§ 371 Date: Sep. 20, 2022

(51) Int. Cl. G06N 5/02

(52) U.S. Cl. CPC G06N 5/02

(57) ABSTRACT

A method, performed by communications system (100), for a prediction of an event. The first node (111) determines (603) a first set of nodes (121) and sends (604), a first indication of it. The second node (112) determines (606), a vote for one of the nodes in the first set of nodes (121) to be leader, and sends (607) a second indication indicating the determined vote. The second node (112) exchanges (610) a third indication indicating that the third node (113) is the leader. The third node (113) receives (612) from the other nodes in the first set of nodes (121), a respective fourth indication of a respective prediction on the event. The third node (113) updates (613) a machine-learning model of the event based on the received fourth indications and an own prediction, and sends (614), an indication of the updated machine-learning model to another node (114).

### TECHNICAL FIELD

The present disclosure relates generally to a communications system, and methods performed thereby, for handling a prediction of an event. The present disclosure also relates generally to a first node, and methods performed thereby, for handling the prediction of the event. The present disclosure also relates generally to a second node and methods performed thereby, for handling the prediction of the event. The present disclosure also relates generally to a third node and methods performed thereby, for handling the prediction of the event.

### BACKGROUND

Computer systems in a communications network may comprise one or more nodes, which may also be referred to simply as nodes. A node may comprise one or more processors which, together with computer program code may perform different functions and actions, a memory, a receiving port and a sending port. A node may be, for example, a server. Nodes may perform their functions entirely on the cloud.

### Internet of Things (IoT)

The Internet of Things (IoT) may be understood as an internetworking of devices, e.g., physical devices, vehicles, which may also referred to as “connected devices” and “smart devices”, buildings and other items—embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as for the control and automation of lighting via e.g., cameras, light monitors, heating, e.g. a “smart” thermostat, ventilation, air conditioning, and appliances such as washers, dryers, ovens, refrigerators or freezers that may use telecommunications for remote monitoring. These devices may collect data with the help of various existing technologies and then autonomously flow the data between other devices.

### Fog Computing

Internet of Things (IoT) devices are flooding in the world and life becomes impossible without IoT devices these days. Also, by 2025, there will be over 75 billion active IoT devices to establish smartness in the present system. The process of sending and retrieving data over the internet or the cloud has become easier, but how this bulk amount of data will be processed is challenging. The growth of IoT has created a demand for Edge Cloud, Fog and cloud platforms as these computing infrastructures are used by those organizations that rely heavily on data. Rather than having to build and maintain computer infrastructures, cloud computing may be understood to enable companies to consume resources such as virtual machine, storage, or an application, as a utility. The fog computing definition may be understood to refer to extending cloud computing to the edge of an enterprise's network. Fog may be understood as another layer of a distributed network environment, and is closely associated with cloud computing and IoT. It may be understood to comprise a decentralized environment for computing in which the infrastructure may provide storage, data, applications, and computations. Fogging may extend the concept of cloud computing to the network edge, making it ideal for IoT and other applications that may require real-time interactions. Fog networking may be understood to mainly utilize the local computer resources rather than accessing remote computer resources, causing a decrease of latency issues and performance further making it more powerful and efficient.

Since the fog computing paradigm may be understood to bring computation, storage, communication locally close to the edge devices as compared to storing data far from the end point in cloud data centers, fog computing may be understood to help to improve efficiency and reduce the amount of data that may need to be transported to the cloud for processing, analysis and storage. Analytics in fog network needs communication, processing and intelligence to be pushed directly into edge nodes. Even though it is mostly used for efficiency reasons, it may also be used for security and compliance reasons. When it comes to latency, fog computing may be understood to have low latency in terms of network. It may also reduce the amount of data that may be sent to the cloud computer, whereas cloud computing does not provide any reduction in data while sending or transforming data. In terms of responsiveness, the response time of the system may be understood to be high in fog computing, as compared to cloud computing. In cloud computing, multiple data sources may be integrated but fogging may be understood to allow both, multiple data sources and devices to be integrated and this may become one among the major differences between cloud and fog computing.

### Federated Learning (FL)

The availability of large amounts of data, such as those collected for example, from IoT devices, may be understood to enable the possibility of analysing such data to make predictions on events, with a high predictive power. To make predictions on events may be understood to refer to building mathematical models that may fit those data, which mathematical models may then be used to make predictions for such events, e.g., what is the fastest route to reach a destination, when there may be most traffic at a particular junction, etc. . . . .

Within this context, there is a growing trend towards training machine learning models cooperatively over networks of such devices using only local training data. Recently, a Federated Learning (FL)-based, decentralized approach is used where the goal is to train a high-quality centralized model, while training data may remain distributed over a large number of clients in a network. Each client may independently compute an update to the current model based on its local data, and may communicate this update to a central server, where the client-side updates may be aggregated to compute a new global model. The FL framework may be understood to differ from conventional distributed machine learning due to the very large number of clients, highly unbalanced and non-Independent and Identically Distributed data available on each client level.

A typical learning process in FL may be understood to need a subset of existing clients download a current model; then, each client may compute an updated model based on their local data; the model updates may then be sent from the selected clients to the sever, and finally the server may aggregate these models, typically by averaging, to construct an improved global model.

FL also opens up a brand-new computing paradigm for Artificial Intelligence (AI). As compute resources inside end devices such as mobile phones are becoming increasingly powerful, especially with the emergence of AI chipsets, AI is moving from clouds and datacenters to end devices. FL may be understood to provide a privacy-preserving mechanism to effectively leverage those decentralized compute resources inside end devices to train machine learning models. Considering that there are billions of mobile devices worldwide, the compute resources accumulated from those mobile devices are way beyond the reach of the largest datacenter in the world. In this sense, FL has the potential to disrupt cloud computing, the dominant computing paradigm today.

FL may be understood to attempt to solve the problems that traditional machine learning leaves on the table. In FL, algorithm training may be understood to move to the edge of the network, so that data may never leave the device, whether it may be a mobile phone or a fog node. Once the model “learns” from the data, the results may be uploaded and aggregated with updates from all the other devices on the network. The improved model may then be shared with the entire network. The systems may be trained by being fed vast quantities of information—for example, studying millions of camera images to learn when an incidence should happen. FL may be understood to also address a common problem with cloud-based AI: communication delays, or latency, between remote devices and the central machine learning system. Reducing latency may be understood to be critical for AI powered IoT devices, such as industrial equipment, where even brief delays between identifying a problem and responding to it may lead to significant damage. Since the intelligence in the device may be understood to be held locally, manufacturers may use FL to bring AI to environments with limited or nonexistent network connections. FL may be understood to empower sectors where data cannot be transferred to third parties for confidentiality reasons, for example, health sector, banks, insurance company, smart city security, etc.

Compared to the centralized training approach, FL may be understood to be a decentralized training approach which may enable fog nodes located at different geographical locations to collaboratively learn a machine learning model while keeping all the personal data that may contain private information on the device. In such a case, fog nodes may benefit from obtaining a well-trained machine learning model without sending their privacy-sensitive personal data to the cloud. To be able to perform FL efficiently, optimization algorithms may be adapted, and various compression schemes can be utilized.

FL has systems, networking and communication bottleneck problems due to frequent exchanges between the central server and the clients. Another problem is that of biasness. In many instances in practice, the resulting learning models may be biased or unfair—discriminating against some protected groups. The target distribution for FL for which the centralized model may be learned is unspecified. In many instances, the uniform distribution may not be the natural objective distribution and that seeking to minimize the expected loss with respect to the specific distribution is risky. This is because the target distribution may be in general quite different from uniform distribution. In many cases, that may result in a suboptimal or even a detrimental performance.

In a distributed computing paradigm, a single processor or computing resource may need to be identified as an organizer, or leader, to distribute some task among other computing resource, which may be referred to as followers. The very nature of wireless networks induces collisions when adjacent nodes transmit at the same time; electing a leader may be understood to allow to better coordinate this process. To implement edge analytics using decentralized and collaborative learning in a highly distributed and hierarchically structured fog network, and to execute localized, modular jobs at different layers and zones within a small group of fog nodes, selecting a leader node may be understood to be very crucial task. A well-coordinated process may be understood to be relevant in a fog network to reduce intra-layer and inter-layer communication overhead at scale. Leader nodes may need to take this charge of coordinating the collaborative process among a group of similar nodes by assigning the modular task, gathering the results and communicating the aggregated result to outside of the group.

As the applications of ubiquitous, connected devices are rapidly increasing computational power and storage capacity in those devices which are increasing in executing the tasks in parallel. The massive data generated from these connected devices shows huge potential to develop significant use cases. This massive data needs to be analyzed at scale to extract the knowledge out of it and traditional machine learning approach is not a good fit here always.

Conventional cloud computing infrastructures leverage geographical centralized data centers using relatively homogeneous commoditized hardware. Such infrastructures were not designed to cater for the processing, storage and data generated by billions of distributed end points operating in dynamic environments with intermittent network connectivity. Due to cloud communication dependency and large volumes of data generated by fog and edge applications, network connectivity and capacity is a significant bottleneck, especially in the case of real-time delay-sensitive applications.

### SUMMARY

It is an object of embodiments herein to improve the handling of a prediction of an event in a communications system. It is a particular object of embodiments herein to improve the prediction of the event by identifying clusters of nodes, or sets of nodes, in the communications system, and facilitating a dynamic selection of leader nodes in the identified clusters, thereby facilitating the handling the prediction of the event by the respective leader nodes between clusters, and in some particular embodiments, across layers in a layered architecture of a communications system.

According to a first aspect of embodiments herein, the object is achieved by a method performed by a communications system comprising a first node, a second node and a third node. The method is for handling a prediction of an event. The communications system comprises a first plurality of nodes. The method comprises determining, by the first node, a first set of nodes in the first plurality of nodes. The determining is based on: i) a first pattern of arrival of service requests received over a first period of time by the first plurality of nodes from a plurality of client computing devices of the first plurality of nodes, ii) a second pattern in a variance of data collected for the service requests of a different type received over a second period of time by a second plurality of nodes in the communications system, iii) a first measure of similarity in a distribution pattern of data collected by the nodes in the first plurality of nodes over the first period of time, about the service requests received of a same type, and iv) a second measure of entropy of the data collected by the nodes in the first plurality of nodes over the first period of time, about the service requests received. The method also comprises sending, by the first node, a first indication to the nodes comprised in the determined set of nodes. The first indication indicates their belonging to the first set of nodes. The method then comprises determining, by the second node, the second node being comprised in the first set of nodes, a vote. The vote is for one of the nodes comprised in the first set of nodes to be candidate for leader node of the first set of nodes in the handling of the prediction of the event. The vote is based on at least one of the following with respect to the candidate: i) available energy resources, ii) average uptime, iii) available computing power, iv) computing latency, v) a communication constraint, the communication constraint being based on an energy cost and a number of connections of the candidate with the other nodes in the first set of nodes, and vi) a probability of state change of the candidate. The method further comprises sending, by the second node a second indication to the nodes in the first set of nodes. The second indication indicates the determined vote. The method also comprises exchanging, by the second node a third indication with the nodes in the first set of nodes. The third indication indicates that the third node is the leader node for the first set of nodes. The exchanging of the third indication is based on the sent second indication. The method further comprises receiving, by the third node, a respective fourth indication from the other nodes in the first set of nodes. The respective fourth indication indicates a respective prediction on the event, e.g., an indication of a respective mathematical model that best fits a respective set of data, to predict the event. The third node is forbidden from accessing a respective set of observations collected by the other nodes in the first set of nodes on the event. The third node is the leader node of the first set of nodes. The method also comprises updating, by the third node, a machine-learning model of the event. The updating is based on the received respective fourth indications, and an own prediction of the third node on the event based on a respective set of observations collected by the third node on the event. This may be understood as modifying a mathematical model, e.g., an existing mathematical model, with the information provided by the other nodes, to improve the predictive power of the model. Finally, the method comprises, sending, by the third node, a fifth indication. The fifth indication indicates the updated machine-learning model to another node in the communications system. At least one of the following applies: i) the another node is a leader node of a second set of nodes comprised in the first plurality of nodes, wherein all nodes in the first plurality of nodes belong to a same layer of nodes in the communications system, and ii) the communications system comprises multiple pluralities of nodes hierarchically organized in a plurality of layers, and the another node is in a different layer of the of the plurality of layers than a layer wherein the third node is comprised.

According to a second aspect of embodiments herein, the object is achieved by a method performed by the first node. The method is for handling the prediction of the event. The first node operates in the communications system comprising the first plurality of nodes. The first node determines the first set of nodes in the first plurality of nodes. The determining is based on: i) the first pattern of arrival of service requests received over the first period of time by the first plurality of nodes from the plurality of client computing devices of the first plurality of nodes, ii) the second pattern in the variance of data collected for the service requests of the different type received over the second period of time by the second plurality of nodes in the communications system, iii) the first measure of similarity in a distribution pattern of data collected by the nodes in the first plurality of nodes over the first period of time, about the service requests received of a same type, and iv) the second measure of entropy of the data collected by the nodes in the first plurality of nodes over the first period of time, about the service requests received. The first node then sends the first indication to the nodes comprised in the determined set of nodes. The first indication indicates their belonging to the first set of nodes.

According to a third aspect of embodiments herein, the object is achieved by a method performed by second node comprised in the first set of nodes of the first plurality of nodes operating in the communications system. The method is for handling the prediction of the event. The second node determines a vote for one of the nodes comprised in the first set of nodes to be candidate for leader node of the first set of nodes in the handling of the prediction of the event. The vote is based on at least one of the following with respect to the candidate: i) the available energy resources, ii) the average uptime, iii) the available computing power, iv) the computing latency, v) the communication constraint, the communication constraint being based on the energy cost and the number of connections of the candidate with the other nodes in the first set of nodes, and vi) the probability of state change of the candidate. The second node sends the second indication to the nodes in the first set of nodes. The second indication indicates the determined vote. The second node then exchanges the third indication with the nodes in the first set of nodes. The third indication indicates that the third node is the leader node for the first set of nodes. The exchanging of the third indication is based on the sent second indication.

According to a fourth aspect of embodiments herein, the object is achieved by a method performed by third node comprised in the first set of nodes of the first plurality of nodes operating in the communications system. The method is for handling the prediction of the event. The third node receives the respective fourth indication from the other nodes in the first set of nodes. The respective fourth indication indicates the respective prediction on the event. The third node is forbidden from accessing the respective set of observations collected by the other nodes in the first set of nodes on the event. The third node is a leader node of the first set of nodes. The third node updates the machine-learning model of the event based on the received respective fourth indications, and the own prediction of the third node on the event based on the respective set of observations collected by the third node on the event. The third node then sends a fifth indication indicating the updated machine-learning model to another node in the communications system. At least one of the following applies: i) the another node is the leader node of the second set of nodes comprised in the first plurality of nodes, and all nodes in the first plurality of nodes belong to a same layer of nodes in the communications system, and b) the communications system comprises multiple pluralities of nodes hierarchically organized in a plurality of layers, and the another node is in a different layer of the of the plurality of layers than the layer wherein the third node is comprised.

According to a fifth aspect of embodiments herein, the object is achieved by the communications system. The communications system comprises the first node, the second node and the third node. The communications system is for handling the prediction of the event. The communications system is configured to comprise the first plurality of nodes. The communications system is further configured to determine, by the first node, the first set of nodes in the first plurality of nodes. The determining is configured to be based on: i) the first pattern of arrival of service requests received over the first period of time by the first plurality of nodes from the plurality of client computing devices the of the first plurality of nodes the, ii) the second pattern in the variance of data configured to be collected for the service requests of the different type configured to be received over the second period of time by the second plurality of nodes in the communications system, iii) the first measure of similarity in the distribution pattern of data configured to be collected by the nodes in the first plurality of nodes over the first period of time, about the service requests configured to be received of the same type, and iv) the second measure of entropy of the data configured to be collected by the nodes in the first plurality of nodes over the first period of time, about the service requests configured to be received. The communications system is further configured to send, by the first node 111, the first indication to the nodes comprised in the determined set of nodes. The first indication is configured to indicate their belonging to the first set of nodes. The communications system is further configured to determine, by the second node, the second node being configured to be comprised in the first set of nodes, the vote. The vote is for one of the nodes configured to be comprised in the first set of nodes to be candidate for leader node of the first set of nodes in the handling of the prediction of the event. The vote is configured to be based on at least one of the following with respect to the candidate: i) the available energy resources, ii) the average uptime, iii) the available computing power, iv) the computing latency, v) the communication constraint, the communication constraint being configured to be based on the energy cost and the number of connections of the candidate with the other nodes in the first set of nodes, and vi) the probability of state change of the candidate. The communications system is further configured to send, by the second node, the second indication to the nodes in the first set of nodes. The second indication is further configured to indicate the vote configured to be determined. The communications system is further configured to exchange, by the second node, the third indication with the nodes in the first set of nodes. The third indication is configured to indicate that the third node is the leader node for the first set of nodes. The exchanging of the third indication is configured to be based on the second indication configured to be sent. The communications system is further configured to receive, by the third node, the respective fourth indication from the other nodes in the first set of nodes. The respective fourth indication is configured to indicate the respective prediction on the event. The third node is configured to be forbidden from accessing the respective set of observations configured to be collected by the other nodes in the first set of nodes on the event. The third node is the leader node of the first set of nodes. The communications system is also configured to update, by the third node, the machine-learning model of the event based on the respective fourth indications configured to be received, and the own prediction of the third node on the event based on the respective set of observations configured to be collected by the third node on the event. The communications system is further configured to send, by the third node, the fifth indication. The fifth indication is configured to indicate the updated machine-learning model to another node in the communications system. At least one of: i) the another node is configured to be the leader node of the second set of nodes configured to be comprised in the first plurality of nodes, and all nodes in the first plurality of nodes are configured to belong to the same layer of nodes in the communications system, and ii) the communications system is configured to comprise multiple pluralities of nodes hierarchically organized in a plurality of layers. The another node is configured to be in a different layer of the of the plurality of layers than the layer wherein the third node is comprised According to a sixth aspect of embodiments herein, the object is achieved by the first node. The first node is for handling the prediction of the event. The first node is configured to operate in the communications system configured to comprise the first plurality of nodes. The first node is configured to determine the first set of nodes in the first plurality of nodes. The determining is configured to be based on: i) the first pattern of arrival of service requests configured to be received over a first period of time by the first plurality of nodes from the plurality of client computing devices of the first plurality of nodes, ii) the second pattern in the variance of data configured to be collected for the service requests of the different type configured to be received over the second period of time by the second plurality of nodes in the communications system, iii) the first measure of similarity in the distribution pattern of data configured to be collected by the nodes in the first plurality of nodes over the first period of time, about the service requests configured to be received of the same type, and iv) the second measure of entropy of the data configured to be collected by the nodes in the first plurality of nodes over the first period of time, about the service requests configured to be received. The first node is also configured to send the first indication to the nodes configured to be comprised in the set of nodes configured to be determined. The first indication is configured to indicate their belonging to the first set of nodes.

According to a seventh aspect of embodiments herein, the object is achieved by the second node. The second node is configured to be comprised in the first set of nodes of the first plurality of nodes configured to operate in the communications system. The second node is for handling the prediction of the event. The second node is further configured to determine the vote. The vote is for one of the nodes configured to be comprised in the first set of nodes to be candidate for leader node of the first set of nodes in the handling of the prediction of the event. The vote is configured to be based on at least one of the following with respect to the candidate: i) the available energy resources, ii) the average uptime, iii) the available computing power, iv) the computing latency, v) the communication constraint, the communication constraint being configured to be based on the energy cost and the number of connections of the candidate with the other nodes in the first set of nodes, and vi) the probability of state change of the candidate. The second node is further configured to send the second indication to the nodes in the first set of nodes. The second indication is configured to indicate the determined vote. The second node is also configured to exchange the third indication with the nodes in the first set of nodes. The third indication is configured to indicate that the third node is the leader node for the first set of nodes. The exchanging of the third indication is configured to be based on the second indication configured to be sent.

According to an eighth aspect of embodiments herein, the object is achieved by the third node. The third node is configured to be comprised in the first set of nodes of the first plurality of nodes configured to operate in the communications system. The third node is for handling the prediction of the event. The third node is further configured to receive the respective fourth indication from the other nodes in the first set of nodes. The respective fourth indication is configured to indicate the respective prediction on the event. The third node is configured to be forbidden from accessing the respective set of observations collected by the other nodes in the first set of nodes on the event. The third node is the leader node of the first set of nodes. The third node is also configured to update the machine-learning model of the event based on the respective fourth indications configured to be received, and the own prediction of the third node on the event based on the respective set of observations configured to be collected by the third node on the event. The third node is further configured to send the fifth indication configured to indicate the machine-learning model configured to be updated to the another node in the communications system. At least one of the following applies: i) the another node is configured to be the leader node of the second set of nodes configured to be comprised in the first plurality of nodes, and all nodes in the first plurality of nodes are configured to belong to the same layer of nodes in the communications system 100, and ii) the communications system is configured to comprise multiple pluralities of nodes hierarchically organized in the plurality of layers. The another node is configured to be in a different layer of the of the plurality of layers than the layer wherein the third node is configured to be comprised.

By the first node determining the first set of nodes, and then sending the first indication to the nodes comprised in the determined set of nodes, the second node comprised in the determined set of nodes is enabled to know which nodes are available to be elected as the leader for the first set of nodes, and then determine the vote. By the second node then exchanging the third indication with the nodes in the first set of nodes, the nodes are enabled to know which node they should send their respective fourth indications to, indicating their respective prediction on the event. The third node, as elected leader is then enabled to manage the update of the machine-learning model according to the received respective fourth indications. These actions enable to perform a hierarchical, decentralized learning method, which may align, for example, with a fog layered architecture. By selecting the sets of nodes, or clusters, the nodes may be grouped contextually for scalable application and control. Clustering may for example provide modularity in a large, hierarchical and widely spread network. A further advantage is that the leader selection methodology enables to eliminate generalized, peer-to-peer federated learning. The decentralized learning of embodiments herein may be understood to enable to transfer global and local beliefs, and not entire model parameters, among leader and follower fog nodes. Hence, communication overhead/latency is enabled to be reduced. A belief may be understood as a learnt mathematical hypothesis. For a single cluster or set of nodes, a local belief may be understood to be generated by a member node and a global belief may be understood to be calculated by a cluster leader node. For a single layer in a layered architecture, a local belief may be understood to be generated by member cluster or set of nodes. A global belief may be understood to be generated by the leader cluster in the same layer. The third node, as leader node, may be understood to enable faster communication related to analytics-specific tasks and location-aware task management. The identification of the leader node may be understood to also be useful for real-time delay-sensitive applications. The leader-based learning may in turn be understood to allow context awareness and modularity in fog layers. Learnt global beliefs may be sent to higher layers for making complex decisions. Embodiments herein allow fog-based analytics to act fast for dynamic events and to the decision making of nodes connected for information related to specific locations. Sometimes, this information may be extended to use in the development of an entire network for specific tasks.

### BRIEF DESCRIPTION OF THE DRAWINGS

Examples of embodiments herein are described in more detail with reference to the accompanying drawings, and according to the following description.

FIG. 1 is a schematic diagram illustrating a fog layered architecture.

FIG. 2 is a schematic diagram illustrating two non-limiting embodiments, in panel a) and panel b) a communications system, according to embodiments herein.

FIG. 3 is a flowchart depicting a method in a first node, according to embodiments herein.

FIG. 4 is a flowchart depicting a method in a second node, according to embodiments herein.

FIG. 5 is a flowchart depicting a method in a third node, according to embodiments herein.

FIG. 6 is a flowchart depicting a method in a communications system, according to embodiments herein.

FIG. 7 is a schematic diagram of some aspects of methods in a communications system, according to embodiments herein.

FIG. 8 is a schematic diagram of some aspects of methods in a communications system, according to embodiments herein.

FIG. 9 is a schematic diagram of some aspects of methods in a communications system, according to embodiments herein.

FIG. 10 is a schematic diagram of some aspects of methods in a communications system, according to embodiments herein.

FIG. 11 is a schematic block diagram illustrating two non-limiting examples, a) and b), of a first node, according to embodiments herein.

FIG. 12 is a schematic block diagram illustrating two non-limiting examples, a) and b), of a second node, according to embodiments herein.

FIG. 13 is a schematic block diagram illustrating two non-limiting examples, a) and b), of a third node, according to embodiments herein.

FIG. 14 is a schematic block diagram illustrating two non-limiting examples, a) and b), of a communications system, according to embodiments herein.

### DETAILED DESCRIPTION

Certain aspects of the present disclosure and their embodiments may provide solutions to the challenges discussed in the background section. There are, proposed herein, various embodiments which address one or more of the issues disclosed herein.

Fog computing may be understood to play an important role in reducing network congestion and facilitating location awareness, mobility support, real-time interactions, scalability and interoperability. Computing at fog leader nodes may be understood to be crucial especially in highly dynamic environments. To manage demand distributed scenarios, massive numbers of small cells may be deployed. The user range may be very limited and therefore handovers may be more frequent, resulting in a heavy burden on the network. Fog leader nodes-based computation may act fast for dynamic events and may be helpful to the decision making of nodes connected for information.

As described earlier, finding the leader fog nodes in fog networking to smoothen the flow of communication and execution of special tasks will be considered as challenging implementations.

Existing methods, such as that of Rebecca Ingram et al. [1], Sudarshan Vasudevan et al. [2] etc., for influential node finder will not be applicable to fog networking due to its inherent characteristics such as: a) low latency and location awareness; b) wide-spread geographical distribution; c) mobility; d) very large number of nodes in a proximity, e) predominant role of wireless access, f) strong presence of streaming and real-time applications, an g) heterogeneity. Also, these systems are not context aware. With these characteristics, to find the leader node among a group of fog nodes is really a challenging task. But the existence of leader node may take care of the huge responsibility of sharing communication details as well as location-aware task management.

Anusha Lalitha et al. [3] proposed a distributed learning algorithm in which nodes update their belief by judicially aggregating information from their local observational data with the model of their one-hop neighbours to collectively learn a model that best fits the observations over the entire network. This fully decentralized peer-to-peer learning with information aggregation from the one-hop neighbours is not fully possible in a layered fog architecture, such as e.g., the OpenFog reference architecture, and when context aware clustering of fog nodes is taken into consideration. The one-hop neighbour approach does not consider any context awareness in the fog nodes. In a layered and wide-spread fog architecture, grouping of nodes may be understood to be required for scalability.

To minimize inter-device communication overhead, Eunjeong Jeong et al. [4] proposed a distributed model training algorithm called Federated Distillation (FD), whose communication payload size is much smaller than that of FL, particularly when the model size is large. In a fog network, a scalable, fast, decentralized learning may be understood to be required, but FD cannot be applied directly in fog based architecture due to the hierarchical nature of a fog network, wide-spread distribution, mobility and availability of context-awareness.

Felix Sattler et al. [5] proposed a Clustered Federated Learning (CFL) approach which exploits geometric properties of the FL loss surface, to group the client population into clusters with jointly train data distributions. However, this approach does not consider context awareness in generating clusters for fog based smart applications. CFL is a post-processing method, as clustering is only performed after FL converges to a stationary point. In a large distributed and hierarchical paradigm such as fog computing, context awareness may be understood to have the utmost importance. Fog may support many novel distributed and scalable use cases and to support those use cases with computational intelligence, understanding their context may be understood to be very important. Hence, FL cannot be applied on all nodes in a layer to find out the clusters. Clustering may be understood to enable modularity in a large, hierarchical and widely spread network such as fog. Clustering may be understood to help in grouping a number of fog nodes contextually for a scalable application and control purpose.

Embodiments herein may be understood to be drawn to a system and method for dynamic selection of fog leader nodes for smart applications at the edge of a communications network.

As an general overview, embodiments herein provide methods that enable, to select some fog nodes in a smart environment, for example, a smart city or Industrial IoT, which may do the processing and analysis by collecting details from peer fog nodes, instead of processing all the details in the cloud. Selecting these fog leader nodes is a challenging task and makes those influential fog nodes to perform actions autonomously, which may be usually taken after consultation with cloud sources. FL may be used in this type of application to induce more security and individual model preparation with earlier global model, e.g., cloud, inputs.

According to embodiments herein, a context aware method may be generated, which may first understand and connect to peer fog nodes by considering the inherent characteristics of fog nodes, and based on the requirements of the connected system may then jointly perform the task to understand the mandatory requirements to execute the necessary event, e.g., the local actions. Embodiments herein may be understood to also aim at providing a distributed learning in Fog paradigm, where intra-layer and inter-layer communication overhead may be minimized.

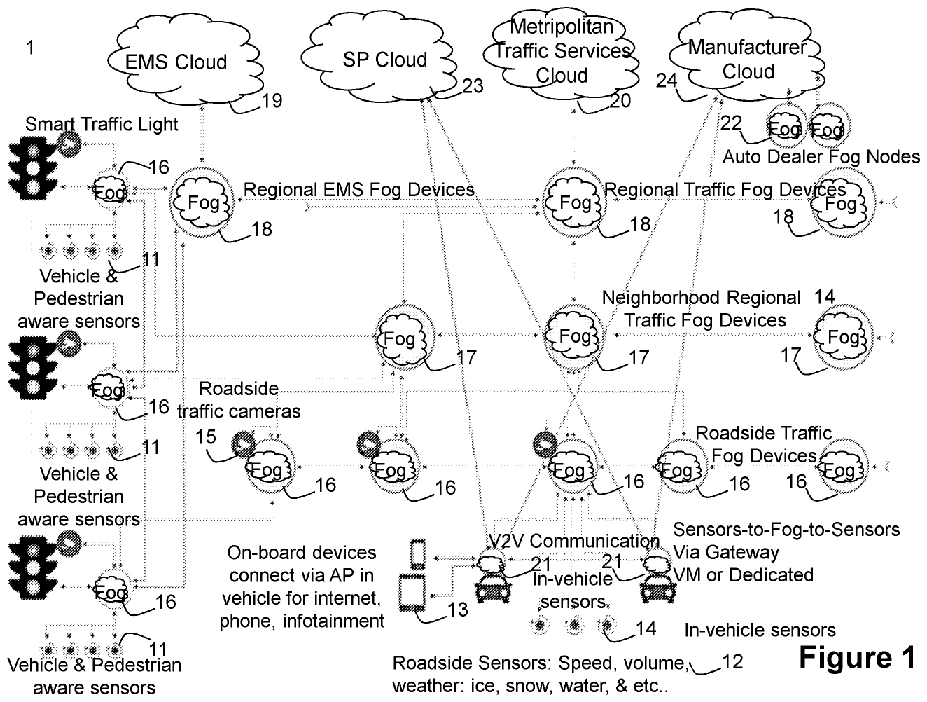

Embodiments herein may be understood to be particularly adapted for a hierarchical fog architecture. A non-limiting example of a fog layered architecture in a smart transportation is shown as an OpenFog reference architecture in FIG. 1. The architecture shows a multi-layered approach in a fog network 1. As may be appreciated in FIG. 1, at the bottom of the hierarchy, one may find devices, e.g., sensors, such as vehicle and pedestrian aware sensors 11 in e.g., a smart traffic light, road side sensors 12 capable of measuring speed, volume, weather e.g., ice, snow, water, etc. . . . , on-board devices 13 that may connect via an Access Point (AP) in the vehicle for internet, phone, or infotainment services, in vehicle sensors 14, road side traffic fog devices 15, e.g., cameras. Information from these devices may then be provided upward, to successive levels of nodes, based on the hierarchy of the architecture. Different vertical application use cases may use a fog hierarchy differently. In a smart city, there may be fog nodes in a region, neighbourhood, street corner, and building level. In a smart factory, the hierarchy may be divided by assembly lines, manufacturing cells, and machines. In most fog deployments, there may usually be several tiers (N-tiers) of nodes. In the particular example depicted in FIG. 1, the lower level devices provide information to respective roadside traffic fog devices 16, which may in turn feed information to the next level fog nodes, neighbourhood traffic fog devices 17, which may then provide information to the next level fog nodes, regional traffic fog devices 18, which may in turn provide information to an Enterprise Mobility Suite (EMS) cloud 19 or a Metropolitan Traffic Services Cloud 20. The number of tiers in a fog deployment may be dictated by the scenario requirements, such as: amount and type of work required by each tier, number of sensors, capabilities of the nodes at each tier, latency between nodes and latency between sensors and actuation, reliability/availability of nodes etc. In general, each level of the N-tier environment may be sifting and extracting meaningful data to create more intelligence at each level. Tiers may be created in order to deal efficiently with the amount of data that may need to be processed and provide better operational and system intelligence. In the particular example depicted in FIG. 1, first level fog nodes 21, such as auto dealer Fog nodes 22 may provide their information directly to a Service Provider (SP) cloud 23 and a Manufacturer cloud 24. The information may be exchanged reciprocally in a Sensors-to-Fog-to-Sensors direction via a Gateway Virtual Machine (VM) or Dedicated. The first level fog nodes 21 may exchange Vehicle to Vehicle (V2V) Communication. Embodiments herein may use one such architecture to evolve leader nodes for the smarter execution of applications.

A typical FL model is not suitable in fog architecture due to fog's inherent characteristics like location awareness, wide-spread geographical distribution, mobility, dense presence of nodes, presence of streaming and real-time applications, heterogeneity etc. In this proposed system and method, we aim to bring hierarchical FL to address the limitations of decentralized learning and peer-to-peer learning in Fog paradigm. Here every fog hierarchical stage will have a leader node for executing a local model. As an general overview, embodiments herein may be understood to provide a new fog leader selection algorithm to fit FL such as distributed, decentralized learning, in a hierarchical fog environment. The systems and methods according to embodiments herein may comprise the following procedures:

a. A local cluster finding procedure that may generate local clusters of fog nodes based on context. The context may be derived from a service request pattern of fog nodes to execute some special tasks, variance pattern and mutual information.

b. A procedure to find out the fog nodes which may show the leadership quality; decentralized learning inputs which may usually trigger and improve the global model may be considered as one responsibility of a leader node.

c. A same layer learning procedure using fog nodes in a same cluster that learn a global belief from a set of individual local beliefs, with the help of a leader node. The same procedure may be used to learn a global belief by clusters of the same fog layer. Thus, generalized peer-to-peer learning of FL in a hierarchical architecture such as Fog computing may be dispensed with. Also, unlike FL, only the local and global beliefs may be transferred among the leader node and other fog nodes and not the entire model parameters. Hence, the communication overhead is enabled to be reduced in relation to location-aware task management.

In a particular aspect, embodiments herein, in contrast to CFL, may generate clusters of fog nodes considering the context awareness, and may then execute decentralized learning with the leader nodes as coordinators.

The above systems and methods may be understood to allow fog-based analytics to act fast for dynamic events and be helpful to the decision making of nodes connected for information related to specific locations. Sometimes, this information may be extended to use in the development of the entire fog networking for specific tasks.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from LTE/5G has been used in this disclosure to exemplify the embodiments herein, this should not be seen as limiting the scope of the embodiments herein to only the aforementioned system. Other wireless systems with similar features, may also benefit from exploiting the ideas covered within this disclosure.

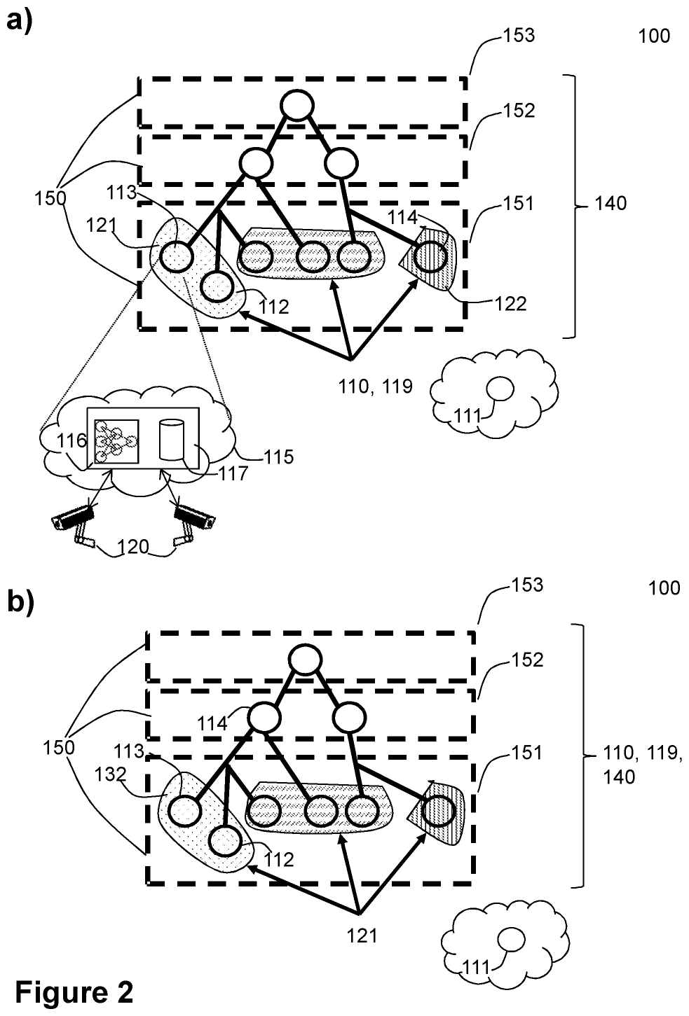

FIG. 2 depicts two non-limiting examples, in panel a) and panel b), respectively, of a communications system 100, in which embodiments herein may be implemented. In some example implementations, such as that depicted in the non-limiting example of FIG. 2, the communications system 100 may be a computer network. In other example implementations, the communications system 100 may be implemented in a telecommunications network, sometimes also referred to as a cellular radio system, cellular network or wireless communications system. In some examples, the telecommunications network may comprise network nodes which may serve receiving nodes, such as wireless devices, with serving beams.

In some examples, the telecommunications network may for example be a network such as 5G system, or Next Gen network or an Internet service provider (ISP)-oriented network. The telecommunications system 100 may also support other technologies, such as a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (VVCDMA), Universal Terrestrial Radio Access (UTRA) TDD, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (VViMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system.

Although terminology from Long Term Evolution (LTE)/5G has been used in this disclosure to exemplify the embodiments herein, this should not be seen as limiting the scope of the embodiments herein to only the aforementioned system. Other wireless systems, support similar or equivalent functionality may also benefit from exploiting the ideas covered within this disclosure. In future radio access, e.g., in the sixth generation (6G), the terms used herein may need to be reinterpreted in view of possible terminology changes in future radio access technologies.

A first plurality of nodes 110 may be comprised in the communications system 100, whereof a first node 111, a second node 112, and a third node 113, are depicted in FIG. 2. A node is schematically represented by a circle in FIG. 2. The communications system 100 also comprises another node 114. The another node 114 may be considered as a fourth node in the communications system 100, and therefore have a description corresponding to that provided for any of the first node 111, the second node 112, and the third node 113.

Each of the first node 111, the second node 112, the third node 113 and the another node 114 may be understood, respectively, as a first computer system or server, a second computer system or server, a third computer system or server, and a fourth computer system or server. Any of the first node 111, the second node 112, the third node 113 and the another node 114, may be implemented as a standalone server in e.g., a host computer in the cloud 115. In other examples, any of the first node 111, the second node 112, the third node 113 and the another node 114 may be a distributed node or distributed server, such as a virtual node in the cloud 115, and may perform some of its respective functions locally, e.g., by a client manager, and some of its functions in the cloud 115, by e.g., a server manager. In other examples, any of the first node 111, the second node 112, the third node 113 and the another node 114, may perform its functions entirely on the cloud 115, or partially, in collaboration or collocated with a radio network node. Yet in other examples, any of the first node 111, the second node 112, the third node 113 and the another node 114, may also be implemented as processing resource in a server farm. Any of the first node 111, the second node 112, the third node 113 and the another node 114, may be under the ownership or control of a service provider, or may be operated by the service provider or on behalf of the service provider.

Any of the first node 111, the second node 112, the third node 113 and the another node 114, may be a core network node in a core network, which may be e.g., a 3GPP SBA based 5GC core network. Any of the first node 111, the second node 112, the third node 113 and the another node 114, may, in some embodiments, have the capability to determine, e.g., derive or calculate, one or more respective machine-learning models 116, respectively, which may be stored, in a respective database or memory 117.

In typical embodiments, the first node 111, the second node 112, and the third node 113, and the another node 114 may be Fog nodes.

In some examples, any of the first node 111, the second node 112, the third node 113, and the another node 114 may be co-located, or be the same node. In typical embodiments, however, the first node 111, the second node 112, the third node 113, and the another node 114 may be located in separate locations geographically.

It may be understood that the communications system 100 may comprise additional nodes. The communications system comprises a second plurality of nodes 119. The second plurality of nodes 119 may be understood as a group of nodes equivalent to that of the first plurality of nodes 110. The nodes comprised in the second plurality of nodes 119 may be the same as those comprised in the first plurality of nodes 119, or they may be different. The second plurality of nodes 119 is used herein to denote that information may be obtained from different groups of nodes that are not exactly the same as the first group of nodes 110, e.g. maybe because the information is not available, or not applicable. In the non-limiting example of FIG. 1, the first plurality of nodes 110 and the second plurality of nodes 119 are the same.

Any of the first node 111, the second node 112, the third node 113 and the another node 114 may manage, respectively, a plurality of client computing devices 120. This is schematically depicted with two devices 120 in FIG. 2a), and only for the third node 113, to simplify the Figure. Any of the devices is the plurality of client computing devices 120 may be a UE or a Customer Premises Equipment (CPE) which may be understood to be enabled to communicate data, with another entity, such as a server, a laptop, a Machine-to-Machine (M2M) device, device equipped with a wireless interface, or any other radio network unit capable of communicating over a wired or radio link in a communications system such as the communications system 100. The plurality of client computing devices 120 may be also e.g., a mobile terminal, wireless device, wireless terminal and/or mobile station, mobile telephone, cellular telephone, or laptop, just to mention some further examples. Any of the devices in the plurality of client computing devices 120 may be, for example, portable, pocket-storable, hand-held, computer-comprised, a sensor, camera, or a vehicle-mounted mobile device, enabled to communicate voice and/or data, via a RAN, with another entity, such as a server, a laptop, a Personal Digital Assistant (PDA), or a tablet computer, sometimes referred to as a tablet with wireless capability, or simply tablet, a Machine-to-Machine (M2M) device, a device equipped with a wireless interface, such as a printer or a file storage device, modem, Laptop Embedded Equipped (LEE), Laptop Mounted Equipment (LME), USB dongles or any other radio network unit capable of communicating over a wired or radio link in the communications system 100. Any of the devices in the plurality of client computing devices 120 may be enabled to communicate wirelessly in the communications system 100. The communication may be performed e.g., via a RAN and possibly one or more core networks, comprised within the communications system 100. Any of the respective plurality of client computing devices 120 may have a capability to collect data about an event over time. In the non-limiting example of FIG. 2, the devices in the respective plurality of client computing devices 120 are cameras.

One or more sets of nodes, such as a first set of nodes 121 and a second set of nodes 122 may be distinguished in the first plurality of nodes 110 according to embodiments herein, as will be explained later. The first plurality of nodes 110 may further comprise a plurality of second sets of nodes 132.

The communications system 100 may comprise multiple pluralities of nodes 140 hierarchically organized in a plurality of layers 150. In the non-limiting example in FIG. 2, the plurality of layers 150 comprises: a first layer 151, a second layer 152 and a third layer 153, although it may be understood that the number of layers may differ from one example to the other. The nodes in the first plurality of nodes 110 may be all comprised in the same layer, as depicted in the non-limiting example of FIG. 2a), where they are all comprised in the first layer 151, or across different, or all layers, as in the non-limiting example of FIG. 2b).

In the non-limiting example of FIG. 2a), the first set of nodes 121 and the second set of nodes 122 are both comprised in the same first layer 151. In the non-limiting example of FIG. 2b), the first set of nodes 121 comprises a plurality of second sets of nodes 132.

The telecommunications network that may be comprised in the communications system 100 may also comprise a plurality of radio network nodes, e.g., access nodes, or radio network nodes. This is not depicted in FIG. 2 to simplify the figure. The telecommunications network that may be comprised in the communications system 100 may cover a geographical area, which in some embodiments may be divided into cell areas, wherein each cell area may be served by a radio network node, although, one radio network node may serve one or several cells. Any of the radio network nodes may be e.g., a gNodeB. That is, a transmission point such as a radio base station, for example an eNodeB, or a Home Node B, a Home eNode B or any other network node capable to serve a wireless device in the communications system 100. Any of the radio network nodes may be of different classes, such as, e.g., macro eNodeB, home eNodeB or pico base station, based on transmission power and thereby also cell size. In some examples, any of the radio network nodes may serve receiving nodes with serving beams. Any of the radio network nodes may support one or several communication technologies, and its name may depend on the technology and terminology used. Any of the radio network nodes may be directly connected to one or more core networks in the telecommunications network.

Any of the nodes in the communications system 100 may communicate with each other with a link. This is schematically represented in FIG. 2 with reciprocal arrows, which are not numbered to simplify the figure. Any of the links may be e.g., a radio link, an infrared link, or a wired link. Any of the links may be a direct link or may be comprised of a plurality of individual links, wherein it may go via one or more computer systems or one or more core networks, which are not depicted in FIG. 2, or it may go via an optional intermediate network. The intermediate network may be one of, or a combination of more than one of, a public, private or hosted network; the intermediate network, if any, may be a backbone network or the Internet; in particular, the intermediate network may comprise two or more sub-networks, which is not shown in FIG. 2.

In general, the usage of “first”, “second”, “third”, “fourth” and/or “fifth”, herein may be understood to be an arbitrary way to denote different elements or entities, and may be understood to not confer a cumulative or chronological character to the nouns they modify.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

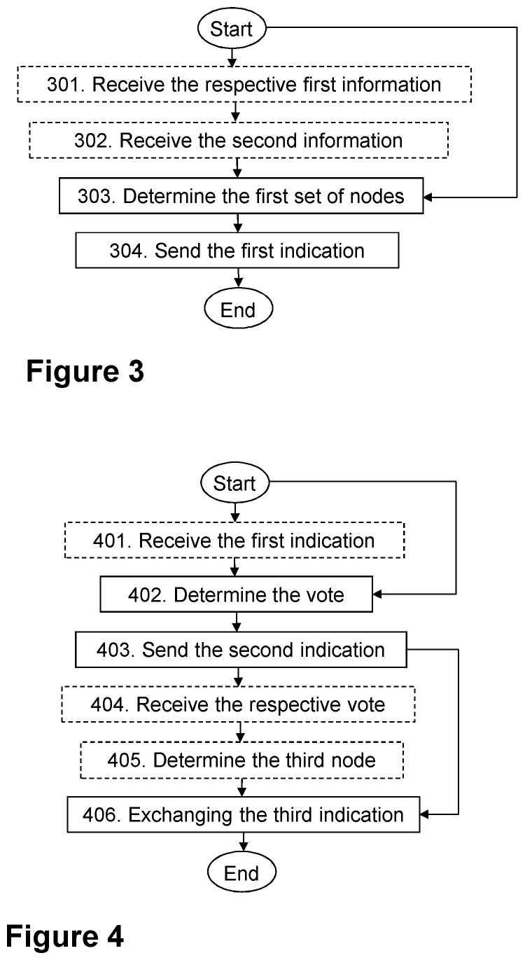

Embodiments of a method, performed by the first node 111, will now be described with reference to the flowchart depicted in FIG. 3. The method may be understood to be for handling a prediction of an event. The first node 111 may operate in the communications system 100 comprising a first plurality of nodes 110

The method may comprise the actions described below. In some embodiments some of the actions may be performed. In some embodiments all the actions may be performed. In FIG. 3, optional actions are indicated with a dashed box. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

Action 301

As discussed earlier, each of the nodes in the first plurality of nodes 110 may have a respective set of client computing devices, e.g., cameras, attached to it, that is, devices comprised in the plurality of client computing devices 120. The client computing devices may collect or sense data from the environment. In the course of operations in the communications system 100, each of the first node 111, the second node 112, the third node 113 and the another node 114 may collect data towards a common problem, e.g., monitoring traffic. In such a context, the prediction of the event may be to predict a location where a car driving over the speed limit may be found. The data may be based on, e.g., video recordings in a smart city, where the first node 111, the second node 112, the third node 113 and the another node 114 may be located.

The nodes in the first plurality of nodes 110 may be unable to share any of the raw data with each other in inter-node communications, e.g., for security reasons. For example, the nodes in the first plurality of nodes 110 may be fog nodes.

As one of the aspects in the handling of the prediction of the event with decentralized learning according to embodiments herein, the first node 111 may be responsible for discovering local clusters of nodes, e.g., fog nodes. The purpose of discovering the local clusters, e.g., sets of nodes, or groups of nodes, may be understood to be to help in grouping a number of fog nodes contextually for scalable application and control purpose. Clustering may for example provide modularity in a large, hierarchical and widely spread network like fog.

In order to eventually identify the clusters or sets of nodes, that may be useful to process data in order to predict the event, in this Action 301, the first node 111 may receive, respectively from each of the nodes in the first plurality of nodes 110, respective first information. According to a first option, the respective first information may be regarding: an arrival of service requests received over a first period of time by the first plurality of nodes 110 from a plurality of client computing devices 130 of the first plurality of nodes 110. A service request may be for example, a traffic condition service or a weather condition service. According to this option, the first node 111 may detect the pattern of arrival of services requests from clients. The first period of time may be, e.g., during training phase.

According to a second option, the respective first information may be regarding data collected for service requests received by a second plurality of nodes 119 in the communications system 100 over a second period of time. The service requests may be of different types, for example weather and traffic, or of the same type, for example, two different measures of pollution. The second plurality of nodes 119 may be understood here to indicate that the data may be collected from a different or not exactly the same group of nodes as those in the first plurality of nodes 110.

According to a third option, the respective first information may be regarding data collected by the first plurality of nodes 110 over the first period of time, about the service requests received. In this case, the data analysed may be contextually similar data, that is data of the same type, such as, for example, do CO₂ and NO₂ measurements, both being indicators of pollution, or data of different types.

The receiving in this Action 301 may be implemented through a peer-to-peer, or broadcast, protocol.

By receiving the first information in this Action 301, the first node 111 may then be enabled to analyze it in Action 303 to identify one or more clusters of nodes with the purpose of predicting the event. For example, by receiving the first information according to the second option and the third option, the first node 111 may then be enabled to compare weather data from different points of the city, that is, collected from different pluralities of nodes.

Action 302

In this Action 302, the first node 111 may receive, from another node 114 operating in the communications system 100, second information regarding the service requests received over the second period of time.

The another node 114 may be in this Action 302, for example, a cloud server-side application.

The second information may be a variance pattern of data collected for service requests, that is, a measure of services that vary together, namely, an association of services that may have been discovered by trend analysis, e.g., correlated, location specific variance in trends, etc. . . . .

By receiving the second information in this Action 302, the first node 111 may then be enabled to analyze it in Action 303 to identify one or more clusters of nodes with the purpose of predicting the event. Receiving the second information may then enable the first node 111 to answer questions such as, according to weather, does traffic vary?

Action 303

Once the first node 111 may have gathered the first information and/or the second information, it may be ready to try to identify a cluster of nodes, based on the particular event it may wish to predict. The clusters or sets of nodes may be formed based on three different properties, by finding a) service request pattern, b) variance pattern and c) availability of mutual information.

Accordingly, in this Action 303, the first node 111 determines a first set of nodes 121, that is, a cluster, in the first plurality of nodes 110. The determining in this Action 303 is based on: i) a first pattern of arrival of the service requests received over the first period of time by the first plurality of nodes 110 from a plurality of client computing devices 120 of the first plurality of nodes 110, ii) a second pattern in a variance of the data collected for the service requests of the different type received over the second period of time by the second plurality of nodes 119 in the communications system 100, iii) a first measure of similarity in a distribution pattern of data collected by the nodes in the first plurality of nodes 110 over the first period of time, about the service requests received of a same type, and iv) a second measure of entropy of the data collected by the nodes in the first plurality of nodes 110 over the first period of time, about the service requests received.

Determining may be understood as calculating, deriving, or similar itself, or obtaining from another node.

Service Request Pattern:

With regards to the first option i), the first node 111 may calculate, or obtain, what may be referred to herein as a Mutual Request Score. This is because there may be some services, e.g., fog services, which may be mostly called back to back. For example: on a rainy day, traffic condition service requests and weather condition service requests may arrive together quite often. A first pattern of arrival of service requests received over the first period of time by the first plurality of nodes 110 from the plurality of client computing devices 120 of the first plurality of nodes 110 may, for example, be calculated as follows:

$$Mututal Request Score = \frac{support ( service a , service b )}{\vert Service a \vert \cdot \vert Service b \vert}$$

Where, |Service a| may be understood to mean number of times service “a” is called and |Service b| may be understood to mean number of times service “b” is called. In some examples, the first node 111 may determine the first pattern of arrival, by receiving it from nodes in the first plurality of nodes 110 in Action 301.

Variance Pattern:

With regards to the second option ii), the first node 111, may automatically discover, or obtain, the association of services by trend analysis without explicit service requests from clients. From different kind of unique services, e.g., fog services registered, the first node 111 may detect correlated, location specific variance in trends, and thus discover the associated services that vary together, e.g., according to weather, does traffic vary? In some examples, the first node 111 may determine the second pattern in the variance, by receiving it from the another node 114 in Action 303.

Data Distribution:

With regards to the third option iii), the first node 111, may automatically discover if two fog nodes having similar services belong to same data distribution or not. In this case, the data analysed may be contextually similar data, that is data of the same type. For example, do CO₂ and NO₂ measurements, both being indicators of pollution, co-vary?

Availability of Mutual Information:

With regards to the fourth option iv), the second measure of entropy of the data may be also referred to herein as “mutual information”. Mutual information may be understood as a measure of uncertainty about one random variable, given knowledge of another. High mutual information may be understood to indicate a large reduction in uncertainty. To illustrate this concept with an example, let X denote the Probability Density Function (PDF) of a data stream coming from one fog node, and Y denote the PDF of a data stream coming another fog node at same layer whose joint probability distribution is PXY(x, y). The mutual information between them, denoted I(X;Y), may be given by:

I(X;Y)=∫P_{XY}(x,y)log P_{XY}(x,y)

The lesser the mutual information may be understood to mean that the nodes may be weakly connected, and the higher the information may be understood to mean that the nodes may be strongly connected. The higher mutual information may be understood to mean that the nodes are that much closer in sharing certain details.

The determining in this Action 303 may comprise determining a respective weight for each of the first pattern, the second pattern, the first measure and the second measure.

In some embodiments, the determining in this Action 303 may further comprise creating an adjacency matrix M from a network graph, the network graph being based on the determined respective weights.

In some embodiments, the determining in this Action 303 may be performed further based on at least one of: a) a maximum number of nodes allowed to belong to the first set of nodes 121, and b) a geographical location the nodes in the first plurality of nodes 110 have to have to be eligible to belong to the first set of nodes 121.

In some embodiments, the determining in this Action 303 may further comprise performing an agglomerative hierarchical clustering by considering a respective distance between the determined respective weights in the created adjacency matrix M.

The determining in this Action 303 may be performed by analyzing data from every two nodes in the first plurality of nodes 110 at a time.

This Action 303 may be implemented by a neighbourhood selection block inside a hybrid graph generator block. Below is a non-limiting example of an algorithm that may be run by the first node 111, according to this Action 303, to group neighbours which may be understood to be useful for generating context aware local clustering:

Example Algorithm for Local_Cluster_Selection

```
  1. Input: Mutual Request Scores, Pattern Variance scores and Mutual
Information for every two nodes in the same layer, an upper triangular
matrix. Weights such as w1 = weight for Mutual Request Score, w2 =
weight for Pattern Variance score and w3 = weight for mutual
information, ξ = Maximum number of members allowed in a local cluster,
d = geographic proximity limit.
  2. Output: Set of Local Clusters.
  3. Create adjacency matrix M from Hybrid graph having edge weighted
as (w1 * Mutual Request Score + w2 * Pattern Variance score + w3 *
mutual information + w4 * distribution similarity).
  4. Perform Agglomerative Hierarchical clustering by considering the
distance from weights in adjacency matrix.
  5. Repeat step 4 till each cluster contain max ξ members or d is met.
  6. Return clusters.
```

In some embodiments, the first node 111 may in this Action 303 determine the first set of nodes 121 in a fog layer. Action 303 may therefore be performed for local cluster discovery within a fog layer.

In some embodiments, the communications system 100 may comprise multiple pluralities of nodes 140 hierarchically organized in a plurality of layers 150 of pluralities of nodes 140. In some of such embodiments, the determining in this Action 303 may be based on a restriction that all nodes in the first plurality of nodes 110 have to belong to a same layer, e.g., the first layer 151, of the plurality of layers 150.

Action 304

In this Action 304, the first node 111 sends a first indication to the nodes comprised in the determined set of nodes 121. The first indication indicates their belonging to the first set of nodes 110.

The first indication may be for example, “G=<V, E>”, a Local cluster as a connected graph.

The sending in this Action 304 may be implemented through a peer-to-peer, or broadcast, protocol.

By sending the first indication in this Action 304, the first node 111 may enable the nodes in the first set of nodes 121 to know which list of potential candidates they may choose from in order to elect the leader node of the first set of nodes 121.

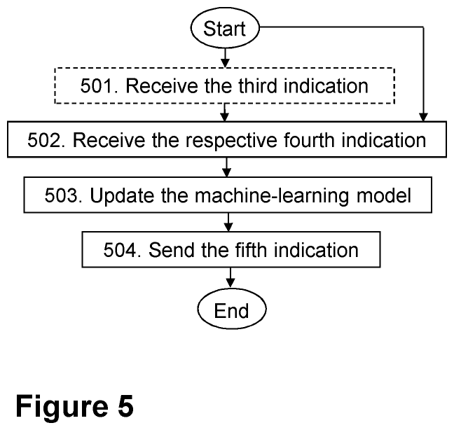

Embodiments of a method performed by the second node 112, will now be described with reference to the flowchart depicted in FIG. 4. The second node 112 is comprised in the first set of nodes 121 of the first plurality of nodes 110 operating in a communications system 100. The method is for handling the prediction of the event. In other words, the second node 112 is comprised in the cluster determined by the first node 111 in or der to predict the event.

The method may comprise the following actions. Several embodiments are comprised herein. In some embodiments, some actions may be performed, in other embodiments, all actions may be performed. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 4, optional actions are represented in boxes with dashed lines.

The detailed description of some of the following corresponds to the same references provided above, in relation to the actions described for the first node 111, and will thus not be repeated here to simplify the description. For example, in some embodiments the communications system 100 may comprise multiple pluralities of nodes 140 hierarchically organized in a plurality of layers 150. In some embodiments, all nodes in the first plurality of nodes 110 may belong to a same layer 151 of the plurality of layers 150.

Action 401

Once the cluster, that is, the first set of nodes 121 may have been identified, nodes comprised in it, such as the second node 112, may cast a vote to elect the leader node of the newly defined set of nodes 111.

In this Action 401 the second node 112 may receive the first indication from the first node 111 comprised in the communications system 100. As stated earlier, the first indication may indicate that the second node 112 is comprised in the first set of nodes 121. By receiving the first indication, the second node 112 may be enabled to know which potential candidates it may choose from in order to elect the leader node.

The receiving in this Action 401 may be implemented through a peer-to-peer, or broadcast, protocol.

Action 402

In this Action 402, the second node 112 determines a vote for one of the nodes comprised in the first set of nodes 121 to be candidate for leader node of the first set of nodes 121 in the handling of the prediction of the event. The vote is based on at least one of the following with respect to the candidate: i) available energy resources, e.g., how much battery the candidate may have to be to perform a task; ii) average uptime, wherein uptime may be understood as an average time for which the node may remain up, that is, the node may have internal battery power; iii) available computing power, e.g., CPU power, memory and storage; iv) computing latency, that is, an amount of time, e.g., in milliseconds of seconds, that may be required to perform a computation job, v) a communication constraint, the communication constraint being based on an energy cost and a number of connections, e.g., hops, of the candidate with the other nodes in the first set of nodes 121, and vi) a probability of state change of the candidate, e.g., changing of state from ON to OFF, ACTIVE to INACTIVE etc. . . . .

An Election Factor (EF) may be used by each of the nodes in a cluster, e.g., each node of the first set of nodes 121, to determine respective votes from all nodes. The Election Factor (EF) may be used as a mapping from m decision factors, Xᵢ, that are associated with node i into the real numbers, such that the larger the EF, the more “desirable” the node may be as a leader.

Decision factors may include, as noted earlier for determining the vote, the node's battery life, average uptime, computing power, CPU power, memory and storage, churn score and a leadership score.

The leadership score of a node may be calculated from a computing latency and a communication constraint of the node. The communication constraint may be calculated from a degree and an energy cost of the node. For node a, the degree of node may be denoted as d(a). Degree stands for number of edges, that is, a line joining two nodes of a graph, which are incident to the node a. E_{ab} may be understood as the amount of energy that may be required to send an electric signal from node a to node b. A minimum weighted spanning tree may be prepared by finding the spanning arborescence of minimum weight in the graph. Here the weight in each edge u̅v̅ may be denoted as Eᵤᵥ. If d(a) is high and energy cost C=Σ_{i∈d(a)}Eₐᵢ is low, then the node “a” may have more chances to spread the information to a large portion of the communications system 100. The higher the degree and smaller the energy cost of a node is, the faster the node may spread the information.

EF may be calculated by a weighted sum of these decision factors.

$$E F = {\sum }_{i = 0}^{m} {W}_{i} \cdot {X}_{i}$$

Here, churn score may be understood as the probability of the fog node to be churned out of the communications system 100, e.g., a fog network. Systems and methods to find out the churn score of fog nodes may be performed according to patent application WO2019123471. The lesser the churn score, the better the probability of a node to be a leader node. Hence this factor may be considered as Xᵢ=1/Churn Score. Since all elector-nodes may be understood to use the same EF, the algorithm may elect the node with the maximum EF value as the leader.

In some embodiments, the determining in this Action 402 may be triggered by the receiving of the first indication in Action 401.

Action 403

In this Action 403, the second node 112 sends a second indication to the nodes in the first set of nodes 121. The second indication indicates the determined vote.

The sending in this Action 403 may be implemented through a peer-to-peer, or broadcast, protocol.

Action 404

Since the other nodes in the first set of nodes 121 may be understood to also cast their respective votes of the leader node, the second node 112 may, in this Action 404, receive a respective vote from each of the other nodes in the first set of nodes 121 for, out of the nodes comprised in the first set of nodes 121, their respective candidate for leader node 113 of the first set of nodes 121.

Action 405

In this Action 405, the second node 112 may determine the third node 113 to be the leader node for the first set of nodes 121. The determining in this Action 405 may be based on the received respective votes in Action 404.

### Example

Action 405 may be implemented for example, according to the algorithm below, which may run an election and find out the leader node n_{L} from all nodes of a local cluster such as the first set of nodes 121. The Election Factor (EF) may be used by each of the nodes in a cluster, e.g., each node of the first set of nodes 121, to determine respective votes from all nodes, as described earlier. The algorithm may be understood to converge within a finite number of steps.

Algorithm: Local_Cluster_Leader_Selection

| | |
|---|---|
| 1. | Input: G = <V, E>: Local cluster as a connected graph. |
| 2. | Output: The leader node n_{L}. |
| 3. | for v ∈ V do |
| 4. | calculate EF for self |
| 5. | broadcast EF to immediate neighbours |
| 6. | end for |
| 7. | Set EF to empty list |
| 8. | Set total_vote for all V as 0 |
| 9. | Set received_vote for all V as 0 |
| 10. | while vote movement is not stopped do: |
| 11. | for v ∈ V do |
| 12. | if EF of any neighbour of v is greater than EF of v then |
| 13. | set total_vote:= received_vote+1 |
| 14. | send total_vote to the neighbour having highest EF |
| 15. | set total_vote:= 0 |
| 16. | end if |
| 17. | if EF of no neighbour of v is greater than EF of v then |
| 18. | set total_vote:= total_vote+1 |
| 19. | end if |
| 20. | if neighbours send vote then |
| 21. | set total_vote:= total_vote + received vote |
| 22. | end if |
| 23. | end for |
| 24. | end while |
| 25. | return node (n_{L}) having highest vote |

Action 406

In this Action 406, the second node 112 may exchange a third indication with the nodes in the first set of nodes 121. The third indication may indicate that the third node 113 is the leader node 113 for the first set of nodes 121. The exchanging of the third indication may be based on the sent second indication in Action 403.

The exchanging, that is sending and/or receiving, in this Action 406 may be performed through a peer-to-peer, or broadcast, protocol.

In some embodiments, the exchanging in this Action 406 may comprise sending 406 the third indication to the nodes in the first set of nodes 121. The third indication may indicate that the third node 113 is the leader node 113 for the first set of nodes 121

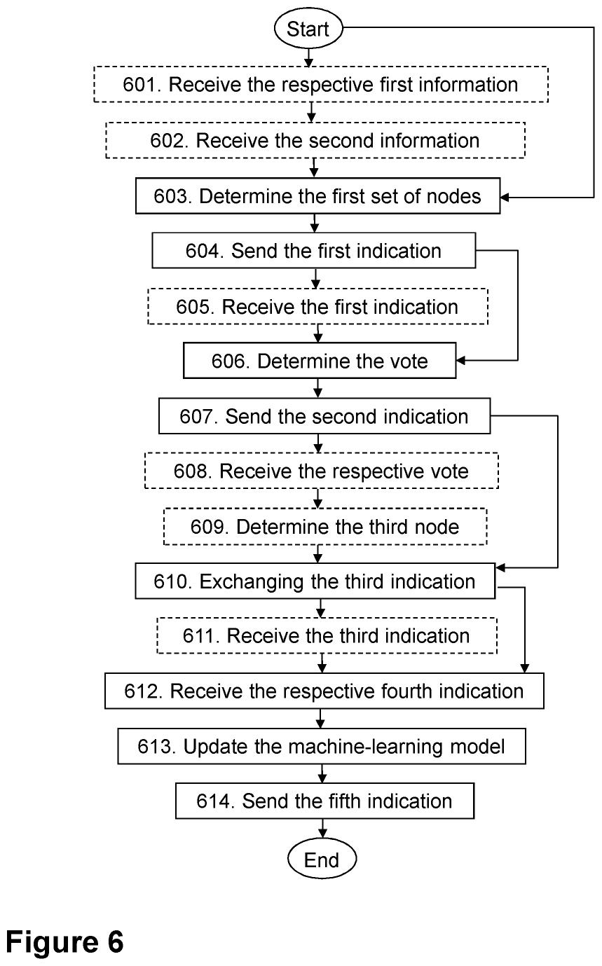

Embodiments of method, performed by the third node 113 comprised in the first set of nodes 121 of the first plurality of nodes 110 operating in the communications system 100, will now be described with reference to the flowchart depicted in FIG. 5. The method is to handle the prediction of the event.

The method may comprise the following actions. Several embodiments are comprised herein. In some embodiments, some actions may be performed, in other embodiments, all actions may be performed. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 5, optional actions are represented in boxes with dashed lines. The detailed description of some of the following corresponds to the same references provided above, in relation to the actions described for the first node 111, and will thus not be repeated here to simplify the description. For example, in some embodiments the communications system 100 may comprise multiple pluralities of nodes 140 hierarchically organized in a plurality of layers 150. In some embodiments, all nodes in the first plurality of nodes 110 may belong to a same layer 151 of the plurality of layers 150.

Action 501

In this Action 501, the third node 113 may receive the third indication from the second node 112 comprised in the first set of nodes 121. The third indication may indicate that the third node 113 is the leader of the first set of nodes 121.

Action 502

In this Action 502, the third node 113 receives a respective fourth indication from the other nodes in the first set of nodes 121. The respective fourth indication indicates a respective prediction on the event. The third node 113 is forbidden from accessing a respective set of observations collected by the other nodes in the first set of nodes 121 on the event. This may be understood to be for e.g., security reasons. The set of observations themselves, e.g., the raw data, may not be allowed to be transferred for confidentiality reasons, such as, e.g., in the health sector, in banks, in an insurance company's smart city security, etc. . . . . This may correspond to examples wherein the nodes in the first set of nodes 121 may be fog nodes. The third node 113 is the leader node of the first set of nodes 121.

The fourth indication may be a “local belief” of each participating node, e.g., within a determined layer Lₙ.

Consider a group of N individual fog nodes at layer Lₙ, e.g., the first layer 151. Nodes at layer Lₙ may be considered to be connected via an undirected graph. The interaction of the nodes may be characterized by a stochastic matrix θ. θᵢⱼ may denote the confidence node i has on the information it may receive from node j. According to embodiments herein, learning criteria may require every node in the layer Lₙ to reach consensus on weights that may best fit the dataset coming from end devices, distributed over the entire layer. The learning algorithm may generate the information that nodes may exchange with each other, such as model parameters/weights, and may dictate the merging of all the information gathered at each node.

Fog nodes at a same layer, e.g., the first layer 151, may be grouped together by forming local clusters, such as the first set of nodes 121 in some embodiments. The learning at layer Lₙ may be two-fold. Each member node of a local cluster “i”, e.g., the first set of nodes 121, may have access to a labelled dataset D. The data may be part of the local space of cluster or a global space. Labelled data points from a local space may be generated with a distribution P(Xᵢ).

Consider m nodes each observing y(i). Let Y={y(1), . . . , y(m)} denote the set of observations of all nodes in the layer Lₙ.

The conditional probability πᵢ=P(y(i)|hₐᵢ) may be considered as the belief of node I, or local belief. P(y(i)|hₐᵢ) may be understood as a probability of y value given the hypothesis hₐᵢ. The log-likelihood of the belief of node i may be defined as Iᵢ:=log(πᵢ).

Action 503

As leader node, the third node 113 may be understood as a representative of the first set of nodes 121 to coordinate a decentralized learning process to predict the event, The third node 113, as leader node, may be responsible for aggregating the local beliefs of the other nodes in the first set of nodes 121 just described, and together with its own local belief, update an existing predictive model e.g., a hypothesis, a machine learning model, of the event, which may be for example, a fastest route to a hospital, an anomaly detection in smart surveillance, appearance of an object for collision avoidance, etc. . . . . Specific non-limiting examples of how this may be implemented will be provided later in different illustrative cases.

In this Action 503, the third node 113 updates a machine-learning model of the event based on the received respective fourth indications, and an own prediction, e.g., its own local belief, of the third node 113 on the event based on a respective set of observations collected by the third node 113 on the event.

The updating in this Action 503 may be performed by updating a global belief b_{g} by taking an average of all local beliefs received from all other nodes in the first set of nodes 121.

In some embodiments, the updating in this Action 503 may be based on minimizing a cross-entropy between the received respective fourth indications and an outcome of the updated machine-learning model.

### Example

To illustrate Action 503, an example will be described here wherein the nodes of the first set of nodes 121 are Fog nodes.

Fog nodes may update their local belief by aggregating information from their local observational data with the model of their same cluster neighbours to collectively learn a model that best fits the observations for the local cluster. These clusters may then collectively learn a model that may best fit the observations over the entire layer Lₙ.

Consider a finite set of learnable weights W. Each node may have access to a set of local likelihood functions. There may be a W* that may be a globally learnable weight set. Learning W* may not be possible using only the local space data of nodes. These nodes may collaborate over local clusters and local clusters may collaborate over layer Lₙ of the fog network to learn the W*. Embodiments herein introduce a new learning algorithm for the purpose of understanding how global learning parameters may relate to the local data instances for specific tasks.

The following is a non-limiting example of how Action 503 may be implemented, when all the nodes in the first set of nodes 121 may be located in the same layer, e.g., the first layer 151 or Lₙ in a procedure that may be referred to as “Same Layer Learning”.

Same Layer Learning Algorithm

| | |
|---|---|
| 1. | Input: Set of local belief located at each participating node at |
| | layer Lₙ |
| 2. | Output: Global belief at layer Lₙ |
| 3. | for node i = 1 to N do in parallel: |
| 4. | Obtain y(i), hₐᵢ, and πᵢ |
| 5. | Send local beliefs to leader node |
| 6. | end for |
| 7. | Leader node updates global belief b_{g} by taking average of all |

local beliefs received from all other nodes

| | |
|---|---|
| 8. | Broadcast global belief to all nodes, according to Action 504 |
| 9. | for node i = 1 to N do in parallel: |
| 10. | Update local belief by learning to minimize Difference |

Regularization where Difference Regularization is the cross-entropy
between local belief and averaged global belief

| | |
|---|---|
| 11. | end for |

Unlike FL, we transfer only the local and global beliefs among leader node and other fog nodes and not the entire model parameters. Hence, the communication overhead is reduced for handling certain tasks needed for location-award task management.

The Same Layer Learning Algorithm may be executed by nodes of every local cluster and then by clusters of same layer, e.g., fog layer, to learn global learnable parameters from their individual local data instances.

There may be two instances of Same Layer Learning Algorithm: one may run among all nodes in each local cluster, and another may run among all local cluster in a layer, e.g., Fog layer. The pseudo code depicted above is written for each node in a local cluster. Node may be replaced with cluster and cluster may be replaced with layer when the second instance of same algorithm may run.

Accordingly, in some embodiments, in which the communications system 100 may comprise multiple pluralities of nodes 140 hierarchically organized in the plurality of layers 150, the updating in this Action 503 may be done in one of the layers, based on the respective fourth indication received from nodes in a lower layer. That is, all nodes in the first set of nodes 121 other than the third node 113 may belong to a same layer 151 of the plurality of layers 150. In other embodiments in which the communications system 100 may comprise multiple pluralities of nodes 140 hierarchically organized in a plurality of layers 150, the updating in this Action 503 may be done based on the respective fourth indication received from the respective leaders of other clusters in a same layer. That is, the first set of nodes 121 may comprise a plurality of second sets of nodes 132, e.g., clusters, of the first plurality of nodes 110 operating in a communications system 100, wherein each of the other nodes in the first set of nodes 121 may be a respective leader of a respective second set of nodes 132 in the plurality of second sets of nodes 132.

Action 504

In this Action 504, the third node 113 sends a fifth indication indicating the updated machine-learning model to another node 114 in the communications system 100. At least one of the following applies: i) the another node 114 is a leader node of a second set of nodes 122 comprised in the first plurality of nodes 110, and all nodes in the first plurality of nodes 110 belong to a same layer 151 of nodes in the communications system 100, see FIG. 2a), and ii) the communications system 100 comprises multiple pluralities of nodes 140 hierarchically organized in a plurality of layers 150, wherein the another node 114 is in a different layer 152 of the of the plurality of layers 150 than a layer 151 wherein the third node 113 is comprised, see FIG. 1b).

The fifth indication may indicate a “global belief” at layer Lₙ.

The sending in this Action 504 may be implemented through a peer-to-peer, or broadcast, protocol.

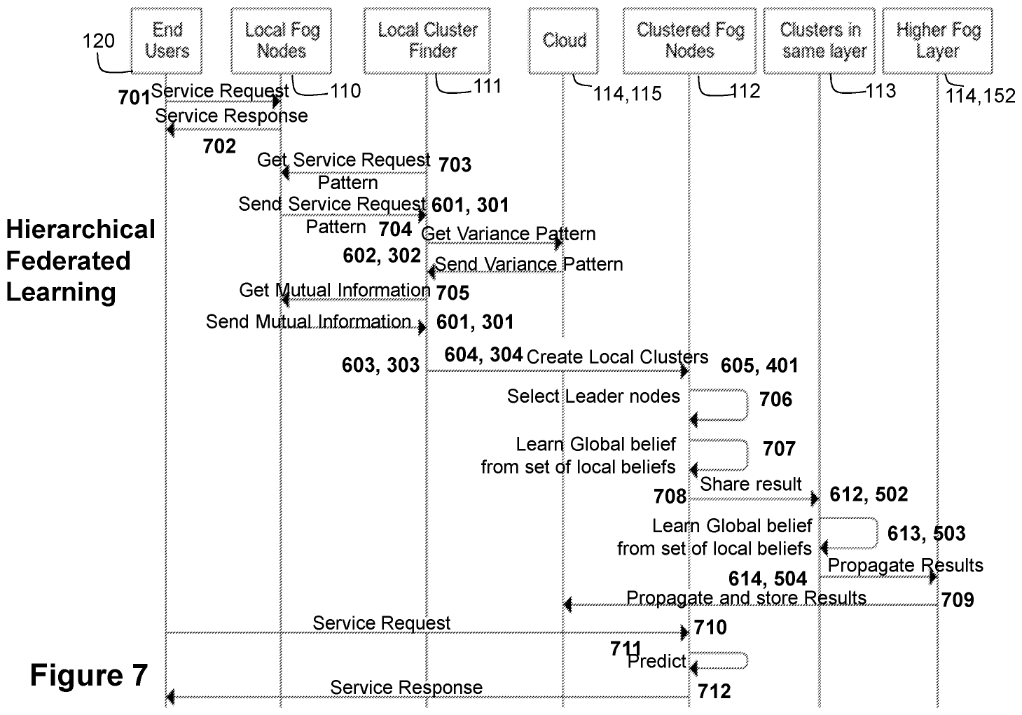

Embodiments of a method performed by the communications system 100, will now be described with reference to the flowchart depicted in FIG. 6. The communications system 100 comprises the first node 111. The method is for handling the prediction of the event. The communications system 100 comprises the first plurality of nodes 110.

The method may comprise the following actions. Several embodiments are comprised herein. In some embodiments, some actions may be performed, in other embodiments, all actions may be performed. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 4, optional actions are represented in boxes with dashed lines.

The detailed description of some of the following corresponds to the same references provided above, in relation to the actions described for the first node 111, the second node 112 and the third node 113, and will thus not be repeated here to simplify the description. For example, in some embodiments the communications system 100 may comprise multiple pluralities of nodes 140 hierarchically organized in a plurality of layers 150. In some embodiments, all nodes in the first plurality of nodes 110 may belong to a same layer 151 of the plurality of layers 150.

Action 601

This Action corresponds to Action 301 described earlier.

In this Action 601, the first node 111 may receive, respectively from each of the nodes in the first plurality of nodes 110, the respective first information regarding: i) the arrival of the service requests received over the first period of time, ii) the data collected for the service requests received by the second plurality of nodes 119, and iii) the data collected by the first plurality of nodes 110 over the first period of time, about the service requests received.

Action 602

This Action corresponds to Action 302 described earlier.

In this Action 602, the first node 111 may receive, from the another node 114 operating in the communications system 100, the second information regarding the service requests received over the second period of time.

Action 603

This Action corresponds to Action 303 described earlier.

In this Action 603, the first node 111 determines, the first set of nodes 121 in the first plurality of nodes 110. The determining 303 is based on: i) the first pattern of arrival of service requests received over the first period of time by the first plurality of nodes 110 from the plurality of client computing devices 130 of the first plurality of nodes 110, ii) the second pattern in a variance of the data collected for the service requests of the different type received over the second period of time by a second plurality of nodes 119 in the communications system 100, iii) the first measure of similarity in the distribution pattern of data collected by the nodes in the first plurality of nodes 110 over the first period of time, about the service requests received of a same type, and iv) the second measure of entropy of the data collected by the nodes in the first plurality of nodes 110 over the first period of time, about the service requests received.

Action 604

This Action corresponds to Action 304 described earlier.

The first node 111, in this Action 604, sends the first indication to the nodes comprised in the determined set of nodes 121. The first indication indicates their belonging to the first set of nodes 110.

Action 605

This Action corresponds to Action 401 described earlier.

In this Action 605, the second node 112 may receive the first indication from the first node 111 comprised in the communications system 100. As stated earlier, the first indication may indicate that the second node 112 is comprised in the first set of nodes 121.

Action 606

This Action corresponds to Action 402 described earlier.

In this Action 606, the second node 112 comprised in the first set of nodes 121, determines the vote for one of the nodes comprised in the first set of nodes 121 to be candidate for leader node 113 of the first set of nodes 121 in the handling of the prediction of the event. The vote is based on at least one of the following with respect to the candidate: i) the available energy resources, ii) the average uptime, iii) the available computing power, iv) the computing latency, v) the communication constraint, the communication constraint being based on an energy cost and a number of connections of the candidate with the other nodes in the first set of nodes 121, and vi) the probability of state change of the candidate.

Action 607

This Action corresponds to Action 403 described earlier.

In this Action 607, the second node 112 sends the second indication to the nodes in the first set of nodes 121. The second indication indicates the determined vote.

Action 608

This Action corresponds to Action 404 described earlier.

In this Action 608, the second node 112 may receive the respective vote from each of the other nodes in the first set of nodes 121 for, out of the nodes comprised in the first set of nodes 121, their respective candidate for leader node 113 of the first set of nodes 121.

Action 609

This Action corresponds to Action 405 described earlier.

In this Action 609, the second node 112 may determine the third node 113 to be the leader node for the first set of nodes 121. The determining in this Action 609 may be based on the received respective votes in Action 404.

Action 610

This Action corresponds to Action 406 described earlier.

In this Action 610, the second node 112 exchanges the third indication with the nodes in the first set of nodes 121. The third indication indicates that the third node 113 is the leader node 113 for the first set of nodes 121. The exchanging of the third indication is based on the sent second indication.

Action 611

This Action corresponds to Action 501 described earlier.

In this Action 611, the third node 113 may receive the third indication from the second node 112 comprised in the first set of nodes 121. The third indication may indicate that the third node 113 is the leader of the first set of nodes 121.

Action 612

This Action corresponds to Action 502 described earlier.

In this Action 612, the third node 113 receives the respective fourth indication from the other nodes in the first set of nodes 121. The respective fourth indication indicates the respective prediction on the event. The third node 113 is forbidden from accessing a respective set of observations collected by the other nodes in the first set of nodes 121 on the event. The third node 113 is the leader node of the first set of nodes 121.

Action 613

This Action corresponds to Action 503 described earlier.

In this Action 613, the third node 113 updates the machine-learning model of the event based on the received respective fourth indications, and the own prediction of the third node 113 on the event based on the respective set of observations collected by the third node 113 on the event

Action 614

This Action corresponds to Action 504 described earlier.

In this Action 614, the third node 113 sends the fifth indication indicating the updated machine-learning model to the another node 114 in the communications system 100. At least one of the following applies: i) the another node 114 is the leader node of the second set of nodes 122 comprised in the first plurality of nodes 110, and all nodes in the first plurality of nodes 110 belong to the same layer 151 of nodes in the communications system 100, see FIG. 2a), and ii) the communications system 100 comprises multiple pluralities of nodes 140 hierarchically organized in the plurality of layers 150, wherein the another node 114 is in a different layer 152 of the of the plurality of layers 150 than a layer 151 wherein the third node 113 is comprised, see FIG. 1b).

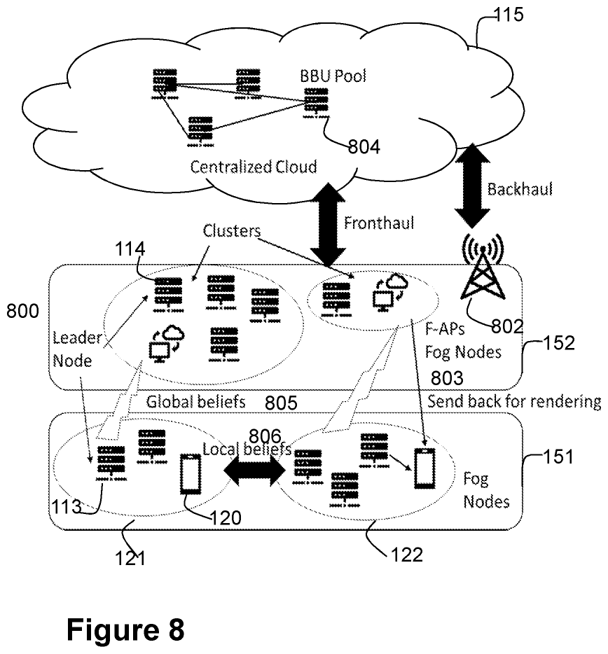

FIG. 7 is a schematic representation of some of the end to end process that may be performed by the nodes comprised in the communications system 100, according to a non-limiting example of embodiments herein. The actions are drawn to handling the prediction of the event using hierarchical federated learning. At 701, the plurality of client computing devices 120, denoted as “End Users”, send, respectively, service requests actions to their respective nodes in the first plurality of nodes 110, which in this example are Local Fog Nodes. At 702, the plurality of client computing devices 120 receive their respective response from the first plurality of nodes 110. At 703, the first node 111, denoted in this example as “Local Cluster Finder”, requests the service request pattern from the first plurality of nodes 110, which it receives as part of the respective first information regarding the arrival of the service requests received over the first period of time according to Actions 301 and 601. At 704, the first node 111 requests the second pattern in the variance from the another node 114, which in this case is a node in the cloud 115, and which second pattern in the variance it receives as second information, in accordance with Action 602 and 302. At 705, the first node 111 requests the second measure of entropy of the data collected by the nodes in the first plurality of nodes 110 over the first period of time, about the service requests received, and receives the mutual information from the first plurality of nodes 110 as part of the first information, in accordance with Action 601 and 301. In accordance with Action 603 and 303, the first node 111 determines the first set of nodes 121, and sends, in agreement with Action 604 and 304, the first indication to the nodes comprised in the determined set of nodes 121, denoted as “Clustered Fog Nodes”, which include the second node 112. The second node 112 receives the first indication in agreement with Action 605 and 401. In this example, the second node 112 is, at 706, also selected as the leader node of the first set of nodes 121 according to Action 405 and 609. At 707, the second node 112 updates the machine-learning model of the event based on the received respective fourth indications, and its own prediction on the event in the manner described in Action 503 and 613. At 708, the second node 112 shares its result with the third node 113, as leader of the clusters in the same layer. The third node 113 receives the respective fourth indication, that is, the set of local beliefs, from the other leaders of the clusters in the same layer according to Action 612 and 502. Then, in agreement with Action 613 and 503, the third node 113 updates the machine-learning model, that is, learns the global belief of the event, based on the received respective fourth indications, and its own prediction, and shares its result with another node 114 in a higher fog layer, e.g, the second layer 152, in agreement with Action 614 and 504. The leader node in the highest layer of the hierarchical architecture of the communications system 100 then propagates and stores the result to the cloud at 709, where it is stored. A future service request received at 710 from one of the devices in the plurality of client computing devices 120, may then prompt the second node 112 to predict the event based on the stored, last updated machine-learning model of the event, and 712, return a service response based on the determined prediction.

Further non-limiting examples of the method in the communications system 100 according to embodiments herein will now be provided with some illustrative use cases.

Case 1. Serving Low Latency Applications with Fog Radio Access Network (RAN)

Cloud RAN (CRAN) and Heterogeneous Cloud RAN (HCRAN) suffer from management complexity, centralized control, additional burden on the fronthaul and backhaul links and lack the usage of local information in the management and optimization of RANs. Fog RAN may be understood to provide a customized and collaborative platform for IoT applications for heterogeneous communication, real-time computation, local storage/cache, resource optimization and application specific functionalities. These may be understood to help in reducing latency, increasing throughput, leveraging contextual and local knowledge and relieving backhaul load. In a 5G network, there may be two types of IoT devices—Massive IoT or Massive Machine Type Communication (MMTC), with large scale applications, and Critical IoT or Critical Machine Type Communication (CMTC), with ultra-low latency applications. The applications range tactile internet, healthcare applications, manufacturing, smart vehicles and transportation, Augmented Reality (AR)/Virtual Reality (VR)/Mixed Reality (MR) and/or Extended Reality (XR) to home automation—everywhere.

a. AR/VR Applications:

The concept of immersive systems has the potential to impact many fields such as healthcare, training, retail, public security, navigation, entertainment etc. AR/VR applications in Fog RAN may require ultra-low latency in communication, as well as computation. For communication, 5G Ultra-Reliable Low-Latency Communication (URLLC) network slice (Slice/Service Type (SST)=2) provides consistent experience under diverse scenarios with high data rate and ultra-low latency. For computation, Fog RAN may push application-layer computing from cloud data centers to mobile edge for ultra-low latency applications. Hence, amalgamation of 5G network with Fog RAN may be especially relevant in this case.

In AR/VR applications, the event to be predicted may be to classify the multimedia, such as: position tracking, depth prediction of frames in video etc., based on user's real location and data from other sources such as—direction (angle), weather, traffic and time.

In AR/VR applications, a tracking module may calculate the relative position of the camera in real time for the correct location and orientation of the virtual components. The computing capability of a single Fog RAN node (FN) may not be enough for the computing-intensive tracking algorithm and overall high Quality of Experience (QoE). Multiple FNs may need to do the application-layer computing collaboratively. Properly handling performance-cost trade-off may be the key here.

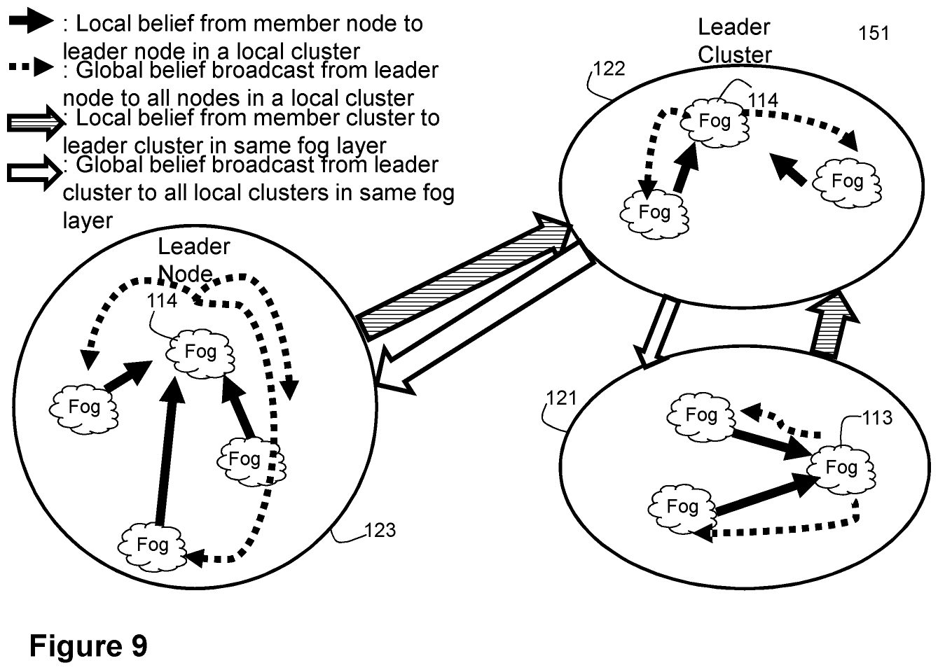

If the number of Fog nodes is increased, it may bring a higher communication cost but there may be a lower computing cost for each node. If a number of assigned tasks for each node is increased, it may bring a higher accuracy, but also a higher computing cost. If nodes are widely spread, then the communication cost may be high again. Hence, deciding a hierarchical structure for distributed nodes, splitting and distributing tasks to them, coordination of the tasks and information sharing may be understood to be relevant for the successful implementation of large-scale AR/VR services. Here, the role of a leader node in the fog network may be understood to play a significant contribution. Embodiments herein may work as follows in a AR/VR content delivery in a F-RAN using a leader node, as schematically illustrated in FIG. 8.

A F-RAN 800 may comprise Macro Remote Radio Heads (MRRHs) 802, Small RRHs (SRRHs) and Fog-computing Access Points (F-APs) 803, which may all connect to the Base Band Unit (BBU) pool 804. Smart user equipment (F-UE) may be the plurality of client computing devices 120, that is, the end devices in the F-RAN. F-APs 803 may implement collaborative radio signal processing locally using their adequate computing and caching capabilities. The contents cached in F-APs 803 may be highly locally relevant.

A VR architecture in F-RAN may comprise a real-world layer and a virtual world layer. The real-world layer may denote the world where users live, whereas the virtual world layer may symbolize the world virtually generated by the resources available. The virtual world space may be created in several adjacent local clusters in a distributed, cooperative manner. This way, leader nodes of adjacent clusters may generate the virtual, or augmented, space, corresponding to their locations.

The first level of the fog hierarchy may be the capturing module consisting of F-UEs. At this level, fog nodes may receive captured images from different sources. To uphold the ultra-low latency application, captured images, that is, data, may not be sent back to the cloud for training. Instead, a decentralized machine learning model may learn from it collaboratively at local fog layers, where leader nodes may coordinate the jobs to handle performance-cost trade off.

The fog nodes may be clustered by a Local Cluster Finder block run by the first node 111, by finding the service request pattern, the variance pattern and the availability of mutual information. Leader nodes may be selected from clustered fog nodes by a Cluster Leader Selection Mechanism run by the second node 112, where the election may be done to find out the leader node in a local cluster. An Election Factor (EF) may be used to determine the respective votes from all the nodes. The leadership score of a node may be calculated from the computing latency and the communication constraint of the node.

The key challenge for the virtual space may be to classify the multimedia based on proper standards. It may be desirable to make each cluster create a unique VR space when the user may exist in the corresponding real location. In addition to the location, data from other sources such as—direction (angle), weather, traffic and time may also be considered for the classification. Leader nodes may collaborate to the decentralized learning used in the VR, for instance, to support sophisticated view synthesis, super-resolution AR/VR etc.

Fog UEs, capturing surrounding events and states, may be collective devices of various sensors with unique features. Functions of different sensor devices and their relationship may be quite complex. Failing of one of the sensor components may also lead to state changes in the fog node. The status of a fog node may change due to internal factors, e.g., device failure, and surrounding factors, e.g., damage due to adversity in environment. Also, fog nodes may have limited computing and storage capacity. A fog node running a specific computation may not be available immediately for some other service request. Since latency sensitive AR/VR applications may require quick fulfilment of the requests using data from heterogeneous sources, as mentioned in last point, where local information may be of utmost importance to create the live-like VR space, collaboration of fog nodes in a clustered manner and dynamically selecting the leader node, the most eligible node available locally, may be crucial in these scenarios.

The clustered fog nodes may perform analysis from locally relevant action and execute autonomous functions, even if connections to higher layers are unavailable. Leader nodes may coordinate the jobs for decentralized learning, assign jobs to other fog nodes and work as representatives of clustered entities. Clustered fog nodes may perform position tracking, depth analysis, view synthesis and learn global beliefs from sets of local beliefs. In the same way, all clusters at the same fog layer, e.g., the first layer 151, may learn a global belief 805 from the set of local beliefs 806. Leader nodes may aggregate the results from other nodes of the same cluster, calibrate the result and communicate the results outside of the cluster e.g., to the second layer 152. The learnt result, the global belief 805, and data from the first layer 151 may be aggregated and sent up the fog hierarchy to the second layer 152 and third layer 153, comprising neighbourhood and regional fog nodes respectively, for further analysis and distribution. Typically, each fog layer in the hierarchy may provide additional computing, storage, and network capabilities in service of the vertical application at their level of the hierarchy. The leader node at layer nearest to a UE may summarize the result and send it back to the UE for rendering.

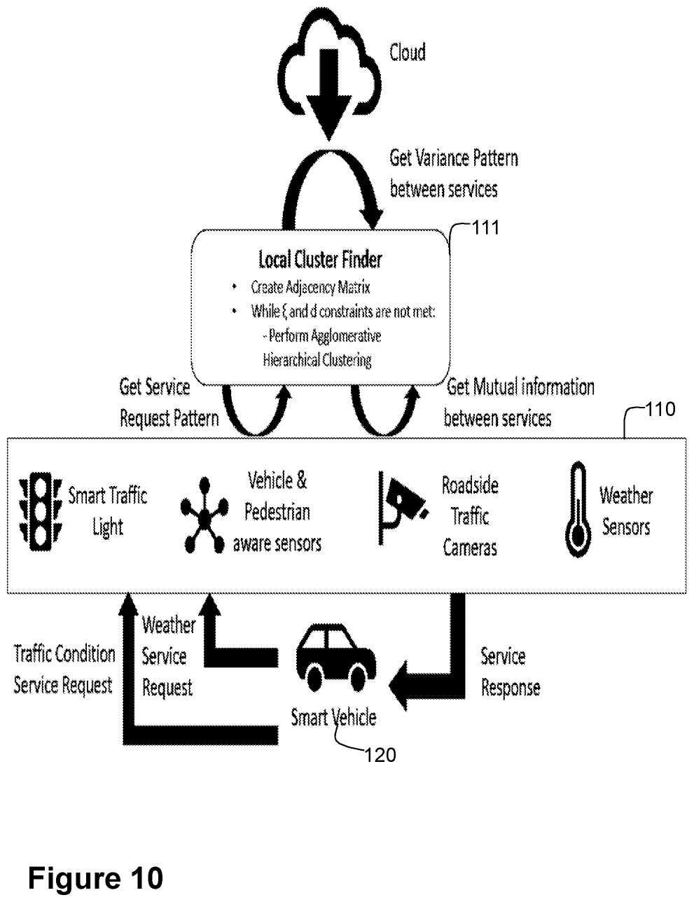

FIG. 9 is a schematic illustration of the entire process of a Same Layer Learning process within a Fog layer, e.g., the first layer 151, comprising the first set of nodes 121 or first cluster, the second set of nodes 122 or second cluster, and a third set of nodes 123, or third cluster. The solid black arrows show how the local beliefs from the member nodes are sent to the leader node of each local cluster. The dotted black arrows show how the global belief is broadcasted from the leader node to all the nodes in a local cluster. The striped arrows show how the local belief from a member cluster is sent to the leader cluster in the same first layer 151, which is here the second set of nodes 122. Finally, the empty arrows show how the global belief is broadcasted from the leader cluster to all the local clusters in the same first layer 151.

For life-like AR/VR spaces with high Quality of Experience (QoE), the virtual world may be made from contextual, location aware, reality-based multimedia data, rather than from synthetic computer graphics. The amount of data that may need to be processed may be very large. It may be efficient to create the virtual world space in several adjacent local clusters in a distributed, cooperative manner, where the cluster leaders may play a pivotal role by assigning tracking tasks, learning from positional information of heterogeneous sources, summarizing results, making complex decisions and creating context-aware VR spaces. Thus, leader controlled, clustered fog layers may become inevitable in bringing high QoE in delay-sensitive applications.

Some other low latency applications using Fog-RAN based leader nodes may be as follows. A first application may be RAN-aware content optimization. Dynamic content optimization may be made based on real-time radio conditions and other local factors to achieve improved video quality and throughput. In RAN-aware content optimization, the event to be predicted may be throughput to be available at the radio downlink interface based on real-time radio conditions and other local factors, etc Leader nodes may learn from radio analytics application and may provide the video server with an indication on the throughput estimated to be available at the radio downlink interface. The information may be used to assist Transmission Control Protocol (TCP) congestion control decisions. A second application may be Edge video Analytics. In Edge video Analytics, the event to be predicted may be a e.g. movement, missing objects, crowd, etc. for public safety, smart cities, etc. Distributed live video streams analytics at the mobile edge may be performed by fog nodes with 5G enhanced Mobile Broadband (eMBB) and Media, Management and Transformation Centre (MMTC) network slices. Leader nodes may coordinate the learning and prediction process augmenting local events and without direct supervision of a central cloud. Events may be triggered automatically, e.g., movement, missing objects, crowd, etc. to enable fast detection and action triggering based on local knowledge. Thus, it may optimize backhaul and transport capacity. Edge video analytics may be applicable to public safety, smart cities etc.

In these ways, dynamic selection of leader nodes in Fog RAN may be understood to play a relevant role in delivering high QoE and QoS in ultra-low latency applications in a smart city environment.

Case 2. Smart Transport System

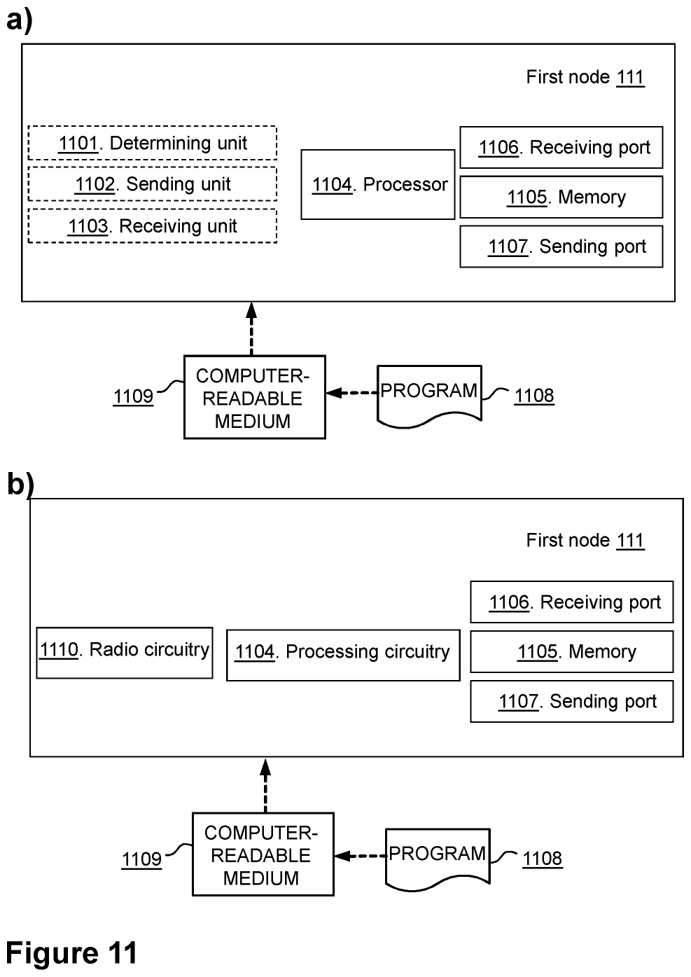

Smart autonomous cars will generate multiple terabytes of data every day from the combinations of Light Detection and Ranging (LIDAR), Global Positioning Systems (GPS), cameras etc. Things may include roadside sensors (infrastructure) and on-vehicle sensors. Smart transportation systems may also manage the actuators that control parts of the infrastructure, such as traffic signals, gates, and digital signs. The vehicles, such as the smart vehicle depicted in FIG. 10, which may comprise the plurality of client computing devices 120, may connect to the cloud and a hierarchy of fog nodes that may service the autonomous vehicle or traffic control systems. In-vehicle fog nodes may provide services including infotainment, Advanced Driver Assistance Systems (ADAS), autonomous driving, collision avoidance, navigation, etc. Several different networking technologies, including Dedicated Short-range Communications (DSRC), cellular, e.g., 3G, LTE, 5G etc., and other networking technologies may securely connect the vehicles to each other and the infrastructure. In a smart transport system, the event to be predicted may be a location and local events for infotainment, predict obstacles for collision avoidance, predict best route for navigation etc When the smart car is coupled with intelligent infrastructure by incorporating machine learning based prediction, a cloud-only analytics model will not work for autonomous transportation, and a fog-based edge analytics approach may be required. Here, the role of leader node in fog networking may be understood to play a significant contribution. The following explains how embodiments herein may be applied in a smart transport system environment:

The first level of the fog hierarchy may be understood to be the first plurality of nodes 110, that is, the infrastructure fog nodes, or roadside fog nodes and on vehicle units. At this level, roadside fog nodes may receive input from other sources, such as roadside cameras, smart traffic light systems, weather sensors, municipal systems and other cloud-based systems and data flows between the traffic control system, infrastructure fog nodes and vehicles in all directions.

The fog nodes may be first clustered at this level by the first node 111 as shown above in FIG. 7, based on the service request pattern, the variance pattern between services, and the mutual information between services. The first node 111 may create an adjacency matrix and perform agglomerative hierarchical clustering until each cluster may contain max members or d is met, as described above in Action 303.

Leader nodes may then be selected from the clustered fog nodes. Leaders nodes may coordinate the modular jobs for decentralized learning and work as representatives of clustered entities. Clustered fog nodes may learn a global belief from the set of local beliefs. In the same way, all clusters at the same fog layer may learn the global belief from the set of local beliefs. Leader nodes may aggregate the results from other nodes of the same cluster, and communicate the results to outside of the cluster.

The clustered fog nodes may perform local analysis for local action, such as alerting the vehicle about poor road conditions, triggering autonomous response to slow down, and perform some autonomous functions, even if connections to higher layers may be unavailable.

The learnt result, that is, the global belief, and data from the first layer may be aggregated and sent up the fog hierarchy to the second and third layers—neighbourhood and regional fog nodes—for further analysis and distribution. Typically, each fog layer in the hierarchy may provide additional computing, storage, and network capabilities in service of the vertical application at their level of the hierarchy.

The result and data may also be distributed east-west to other infrastructure nodes for their use.

### Case 3. Smart Surveillance and Visual Security

Surveillance and security cameras may generate a massive amount of data, which may exceed terabytes per day for a single camera. Traditional cloud models that were deployed for low-resolution cameras are not scalable with the 1080p and 4K cameras because of the sheer availability and/or cost of network transport. Decisions on security may need to be made at the camera or installation location and cannot be made solely in the cloud.

The sheer bandwidth of visual, and other sensor, data being collected over a large-scale network makes it impractical to transport all the data to the cloud to obtain a real-time prediction. Real-time monitoring and detection of anomalies, such as intruders into a building, the fall of an elderly citizen, the misfiring of a piece of manufacturing equipment, etc., pose strict low latency requirements on surveillance systems; timeliness is important from the standpoint of both detection and response. Also, context-awareness and location-awareness in task management may be crucial in these applications. In a smart surveillance system, the event to be predicted may be an anomaly detection. How the proposed systems and methods may work in a smart surveillance system may be as follows:

Fog computing may intelligently partition video processing between fog nodes co-located with cameras and the cloud to enable real-time tracking, anomaly detection, and insights from data collected over long time intervals.

The first level of the fog hierarchy is the first plurality of nodes 110, e.g., the infrastructure fog nodes. At this level, fog nodes may receive input from surveillance cameras and other systems.

Video analytics algorithms may be located on fog nodes close to the cameras and may take advantage of the heterogeneous processor capability of the fog, running the video analytics algorithm in a decentralized manner.

Fog nodes may be clustered by the first node 111 and leader nodes may be chosen by the second node 112. Video analytics algorithms performed by the third node 113 may learn a global belief from a set of local beliefs generated at every fog node from the distributed data. The modular tasks for decentralized, edge-based learning may be assigned to clustered nodes by their leader node. The global belief may be aggregated at the leader node level that may be communicated to other same-layer clusters or higher level of fog layer for further accumulation of actionable insights.

The learnt result, that is, the global belief, and the data from the first layer may be aggregated and sent up the fog hierarchy to the second and third layers—neighbourhood and zonal fog nodes—for further analysis and distribution. For example: in an Airport Surveillance system—parking lot, check-in area, lounge area etc. may have different fog clusters. Decentralized models at this layer may learn to make decisions on anomaly detection at those locations. In a second layer, data and prediction from these different locations may be aggregated for making more complex decisions.

### Case 4. Smart Healthcare and Disaster Management

In the healthcare industry, real-time health monitoring and diagnostics may be understood to be especially relevant. During emergency situations or disasters, transporting patients from one place to another place while providing continuous monitoring and remote diagnostics may be understood to be important. This use case may need to deal with: an intelligent city with smart parking, home and infrastructure, intelligent hospitals linking all aspects for greater patient care and healthcare delivery, intelligent highway systems to optimize hospitalization by reducing travel time, intelligent blood bank and other connected systems, etc. . . . .

How the proposed systems and methods work in smart surveillance system may be as follows:

When a patient is in critical condition and needs immediate hospitalization, he/she needs to be moved efficiently from one place to another. The service requests initiated from smart Ambulance may be grouped together with associated services. For example: an ambulance may need to find out the fastest route to reach the hospital. In this case, a collaboration with a traffic system fog and weather fog may be required, hence they may be clustered and leader nodes may be selected.

The traffic system fog may provide the information regarding current traffic conditions, street conditions, directions, number of vehicles moving in the same direction etc. The weather condition may provide information about the weather, rain, snow fall etc. . . . . The smart vehicle, e.g., an ambulance, may decide the optimal trajectory based on the weather and traffic information received. The prediction and decision making may be performed locally at the fog layer, and the decentralized learning tasks may be executed at each cluster, coordinated by leader nodes to make the localized decisions. These decision results may be further aggregated at the same fog layer, with other clusters, or at a higher layer to make more consolidated decisions for the intended use case.

Once the intended trajectory of the ambulance may be decided, the information may be provided to a higher fog layer. The higher layer, e.g., a zonal fog, may initiate alert notifications to inform other vehicles to give a way to ambulance.

If a request is raised from the ambulance, the next hospital fog systems may collaborate to find out the best possible hospital nearby where the specific treatment and bed may be available. Remote monitoring and diagnostics may be made accordingly. The vehicle fog may collaborate with a blood bank fog to find out the availability of blood of specific groups.

Thus, context aware, dynamic decision making may be performed locally at fog layers in this use case. Here, a localization problem such as transporting a critical patient by ambulance to a suitable hospital in the fastest possible route may be performed with collaboration among local fog systems.

As a summarized overview some aspects of the foregoing, embodiments herein may be understood to be drawn to systems and methods for clustered and hierarchical decentralized learning, to explore the development of leader nodes in hierarchical fog architecture for the benefit of faster communication and context-aware task management. The systems and methods have been introduced to induce relevant functionalities to strengthen the evolution of the leader selection method described herein, which may be exclusively adaptable for hierarchical fog networking for coordination of modular jobs of decentralized learning with clustered nodes. The leader node may be evolved in an optimized way for handling location-aware knowledge related to a dynamic environment that may be considered as a desirable method to implement in the future for smarter applications among cities and industries.

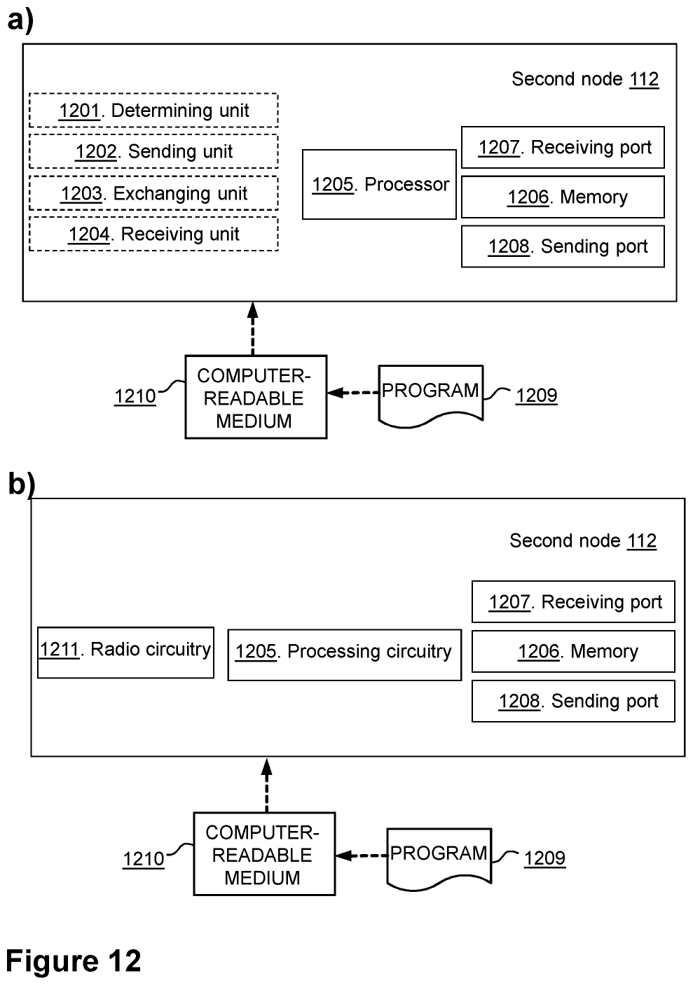

FIG. 11 depicts two different examples in panels a) and b), respectively, of the arrangement that the first node 111 may comprise. In some embodiments, the first node 111 may comprise the following arrangement depicted in FIG. 11a. The first node 111 may be understood to be for handling the prediction of the event. The first node 111 is configured to operate in the communications system 100 configured to comprise the first plurality of nodes 110.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. In FIG. 11, optional units are indicated with dashed boxes.

The detailed description of some of the following corresponds to the same references provided above, in relation to the actions described for the first node 111, and will thus not be repeated here. For example, in some examples, each of the nodes of the first plurality of nodes 110 may be configured to be Fog nodes.

The first node 111 is configured to perform the determining of Action 303, e.g., by means of a determining unit 1101 within the first node 111, configured to determine the first set of nodes 121 in the first plurality of nodes 110. The determining is configured to be based on: i) the first pattern of arrival of service requests configured to be received over the first period of time by the first plurality of nodes 110 from the plurality of client computing devices 120 of the first plurality of nodes 110, ii) the second pattern in a variance of data configured to be collected for the service requests of the different type configured to be received over a second period of time by the second plurality of nodes 119 in the communications system 100, iii) the first measure of similarity in the distribution pattern of data configured to be collected by the nodes in the first plurality of nodes 110 over the first period of time, about the service requests configured to be received of the same type, and iv) the second measure of entropy of the data configured to be collected by the nodes in the first plurality of nodes 110 over the first period of time, about the service requests configured to be received.

The first node 111 is further configured to perform the sending of Action 304, e.g., by means of a sending unit 1102 within the first node 111, configured to send the first indication to the nodes configured to be comprised in the set of nodes 121 configured to be determined. The first indication is configured to indicate their belonging to the first set of nodes 110.

In some embodiments, to determine may be configured to be performed by analyzing data from every two nodes in the first plurality of nodes 110 at a time.

In some embodiments, to determine may be configured to be performed further based on at least one of: a) the maximum number of nodes configured to be allowed to belong to the first set of nodes 121, and b) the geographical location the nodes in the first plurality of nodes 110 have to have to be eligible to belong to the first set of nodes 121.

In some embodiments, to determine may be configured to comprise determining the respective weight for each of the first pattern, the second pattern, the first measure and the second measure.

To determine may be further configured to comprise creating an adjacency matrix M from a network graph. The network graph may be configured to be based on the respective weights configured to be determined.

In some embodiments, to determine may be further configured to comprise performing the agglomerative hierarchical clustering by considering the respective distance between the determined respective weights in the created adjacency matrix M.

In some embodiments, the first node 111 may be further configured to perform the receiving of Action 301, e.g., by means of a receiving unit 1103 within the first node 111, configured to receive, respectively from each of the nodes in the first plurality of nodes 110, respective first information regarding: i) the arrival of the service requests configured to be received over the first period of time, ii) the data configured to be collected for the service requests configured to be received by the second plurality of nodes 119, and iii) the data configured to be collected by the first plurality of nodes 110 over the first period of time, about the service requests configured to be received.

The first node 111 may be further configured to perform the receiving of Action 302, e.g., by means of the receiving unit 1103 within the first node 111, configured to receive from the another node 114 configured to operate in the communications system 100, the second information regarding the service requests configured to be received over the second period of time.

In some embodiments, the communications system 100 may be configured to comprise multiple pluralities of nodes 140 hierarchically organized in the plurality of layers 150 of pluralities of nodes 140, and to determine may be configured to be based on the restriction that all nodes in the first plurality of nodes 110 have to belong to a same layer 151 of the plurality of layers 150.

The embodiments herein in the first node 111 may be implemented through one or more processors, such as a processor 1104 in the first node 111 depicted in FIG. 11a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1105 comprising one or more memory units. The memory 1105 is arranged to be used to store obtained information, store data, configurations, schedulings, and applications etc. to perform the methods herein when being executed in the first node 111.

In some embodiments, the first node 111 may receive information from, e.g., the second node 112, the third node 113, the another node 114, and/or, any other nodes in the first plurality of nodes 110, any of the devices in the plurality of client computing devices 120 and/or any node in the cloud 115, through a receiving port 1106. In some embodiments, the receiving port 1106 may be, for example, connected to one or more antennas in first node 111. In other embodiments, the first node 111 may receive information from another structure in the communications system 100 through the receiving port 1106. Since the receiving port 1106 may be in communication with the processor 1104, the receiving port 1106 may then send the received information to the processor 1104. The receiving port 1106 may also be configured to receive other information.

The processor 1104 in the first node 111 may be further configured to transmit or send information to e.g., the second node 112, the third node 113, the another node 114, and/or, any other nodes in the first plurality of nodes 110, any of the devices in the plurality of client computing devices 120, any node in the cloud 115, and/or or another structure in the communications system 100, through a sending port 1107, which may be in communication with the processor 1104, and the memory 1105.

Those skilled in the art will also appreciate that the units 1101-1103 described above may refer to a combination of analog and digital circuits, and/or one or more processors configured with software and/or firmware, e.g., stored in memory, that, when executed by the one or more processors such as the processor 1104, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1101-1103 described above may be implemented as one or more applications running on one or more processors such as the processor 1104.

Thus, the methods according to the embodiments described herein for the first node 111 may be respectively implemented by means of a computer program 1108 product, comprising instructions, i.e., software code portions, which, when executed on at least one processor 1104, cause the at least one processor 1104 to carry out the actions described herein, as performed by the first node 111. The computer program 1108 product may be stored on a computer-readable storage medium 1109. The computer-readable storage medium 1109, having stored there on the computer program 1108, may comprise instructions which, when executed on at least one processor 1104, cause the at least one processor 1104 to carry out the actions described herein, as performed by the first node 111. In some embodiments, the computer-readable storage medium 1109 may be a non-transitory computer-readable storage medium, such as a CD ROM disc, or a memory stick. In other embodiments, the computer program 1108 product may be stored on a carrier containing the computer program 1108 just described, wherein the carrier is one of an electronic signal, optical signal, radio signal, or the computer-readable storage medium 1109, as described above.

The first node 111 may comprise a communication interface configured to facilitate, or an interface unit to facilitate, communications between the first node 111 and other nodes or devices, e.g., the first node 111, the second node 112, the third node 113, and/or, any other nodes in the first plurality of nodes 110, any of the devices in the respective plurality of devices 170 and/or any node in the cloud 115, and/or or another structure in the communications system 100. The interface may, for example, include a transceiver configured to transmit and receive radio signals over an air interface in accordance with a suitable standard.

In other embodiments, the first node 111 may comprise the following arrangement depicted in FIG. 11b. The first node 111 may comprise a processing circuitry 1104, e.g., one or more processors such as the processor 1104, in the first node 111 and the memory 1105. The first node 111 may also comprise a radio circuitry 1110, which may comprise e.g., the receiving port 1106 and the sending port 1107. The processing circuitry 1104 may be configured to, or operable to, perform the method actions according to FIG. 3, and/or FIG. 6-FIG. 10, in a similar manner as that described in relation to FIG. 11a. The radio circuitry 1110 may be configured to set up and maintain at least a wireless connection with the second node 112, the third node 113, the another node 114, and/or, any other nodes in the first plurality of nodes 110, any of the devices in the plurality of client computing devices 120, any node in the cloud 115, and/or or another structure in the communications system 100. Circuitry may be understood herein as a hardware component.

Hence, embodiments herein also relate to the first node 111 operative to operate in the communications system 100. The first node 111 may comprise the processing circuitry 1104 and the memory 1105, said memory 1105 containing instructions executable by said processing circuitry 1104, whereby the first node 111 is further operative to perform the actions described herein in relation to the first node 111, e.g., in FIG. 3, and/or FIG. 6-FIG. 10.

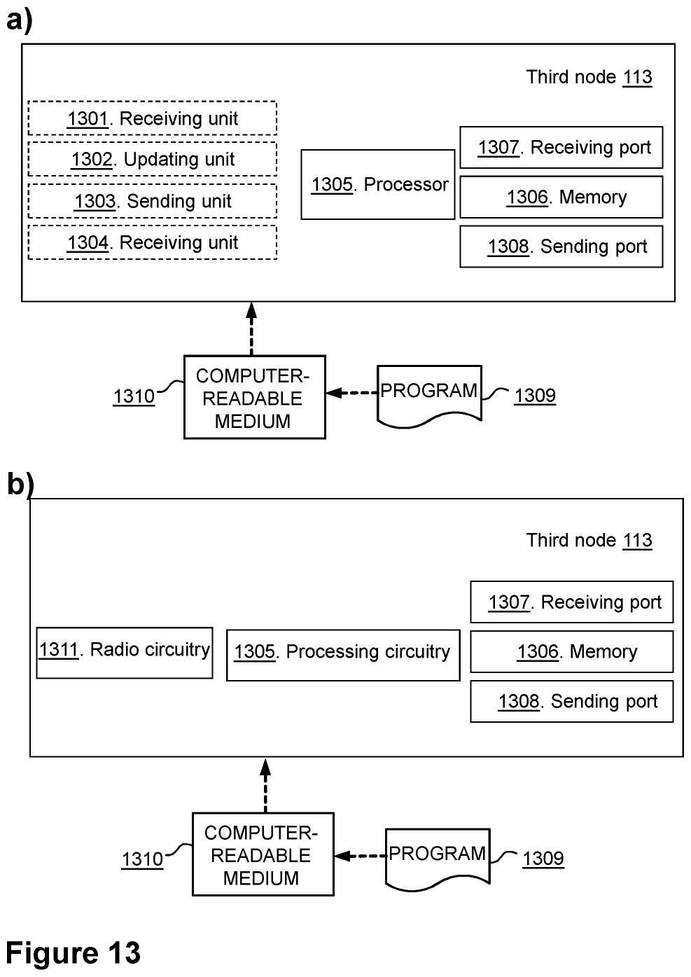

FIG. 12 depicts two different examples in panels a) and b), respectively, of the arrangement that the second node 112, may comprise. In some embodiments, the second node 112 may comprise the following arrangement depicted in FIG. 12a. The second node 112 is configured to be comprised in the first set of nodes 121 of the first plurality of nodes 110 configured to operate in the communications system 100. The second node 112 is for handling the prediction of the event.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. In FIG. 12, optional units are indicated with dashed boxes.

The detailed description of some of the following corresponds to the same references provided above, in relation to the actions described for the second node 112, and will thus not be repeated here. For example, in some examples, each of the nodes of the first plurality of nodes 110 may be Fog nodes.

The second node 112 is configured to perform the determining of Action 402, e.g., by means of a determining unit 1201 configured to, determine the vote for one of the nodes configured to be comprised in the first set of nodes 121 to be candidate for leader node 113 of the first set of nodes 121 in the handling of the prediction of the event. The vote is configured to be based on at least one of the following with respect to the candidate: i) the available energy resources, ii) the average uptime, iii) the available computing power, iv) the computing latency, and v) the communication constraint, the communication constraint being configured to be based on the energy cost and the number of connections of the candidate with the other nodes in the first set of nodes 121, and iv) the probability of state change of the candidate.

The second node 112 is also configured to perform the sending of Action 403, e.g., by means of a sending unit 1202 within the second node 112, configured to, send the second indication to the nodes in the first set of nodes 121. The second indication is configured to indicate the determined vote.

The second node 112 is also configured to perform the exchanging of Action 406, e.g. by means of an exchanging unit 1203 within the second node 112, configured to, exchange the third indication with the nodes in the first set of nodes 121. The third indication is configured to indicate that the third node 113 is the leader node 113 for the first set of nodes 121. The exchanging of the third indication is configured to be based on the second indication configured to be sent.

The second node 112 may be configured to perform the receiving of Action 401, e.g., by means of a receiving unit 1204 within the second node 112, configured to, receive the first indication from the first node 111 configured to be comprised in the communications system 100. The first indication may be configured to indicate that the second node 112 is comprised in the first set of nodes 121. To determine may be configured to be triggered by the receiving of the first indication.

In some embodiments, the second node 112 may be configured to perform the receiving of Action 404, e.g., by means of the receiving unit 1204 within the second node 112, configured to, receive the respective vote from each of the other nodes in the first set of nodes 121 for, out of the nodes configured to be comprised in the first set of nodes 121, their respective candidate for leader node 113 of the first set of nodes 121.

In some embodiments, the second node 112 may be further configured to perform the determining of Action 405, e.g., by means of the determining unit 1201 within the second node 112, configured to, determine the third node 113 to be the leader node 113 for the first set of nodes 121. The determining may be configured to be based on the received respective votes.

In some embodiments, to exchange may be further configured to comprise sending the third indication to the nodes in the first set of nodes 121. The third indication may be configured to indicate that the third node 113 is the leader node 113 for the first set of nodes 121.

The embodiments herein in the second node 112 may be implemented through one or more processors, such as a processor 1205 in the second node 112 depicted in FIG. 12a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1206 comprising one or more memory units. The memory 1206 is arranged to be used to store obtained information, store data, configurations, schedulings, and applications etc. to perform the methods herein when being executed in the second node 112.

In some embodiments, the second node 112 may receive information from, e.g., the first node 111, the third node 113, the another node 114, and/or, any other nodes in the first plurality of nodes 110, any of the devices in the plurality of client computing devices 120 and/or any node in the cloud 115, through a receiving port 1207. In some embodiments, the receiving port 1207 may be, for example, connected to one or more antennas in second node 112. In other embodiments, the second node 112 may receive information from another structure in the communications system 100 through the receiving port 1207. Since the receiving port 1207 may be in communication with the processor 1205, the receiving port 1207 may then send the received information to the processor 1205. The receiving port 1207 may also be configured to receive other information.

The processor 1205 in the second node 112 may be further configured to transmit or send information to e.g., the first node 111, the third node 113, the another node 114, and/or, any other nodes in the first plurality of nodes 110, any of the devices in the plurality of client computing devices 120, any node in the cloud 115, and/or or another structure in the communications system 100, through a sending port 1208, which may be in communication with the processor 1205, and the memory 1206.

Those skilled in the art will also appreciate that the units 1201-1204 described above may refer to a combination of analog and digital circuits, and/or one or more processors configured with software and/or firmware, e.g., stored in memory, that, when executed by the one or more processors such as the processor 1205, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1201-1204 described above may be implemented as one or more applications running on one or more processors such as the processor 1205.

Thus, the methods according to the embodiments described herein for the second node 112 may be respectively implemented by means of a computer program 1209 product, comprising instructions, i.e., software code portions, which, when executed on at least one processor 1205, cause the at least one processor 1205 to carry out the actions described herein, as performed by the second node 112. The computer program 1209 product may be stored on a computer-readable storage medium 1210. The computer-readable storage medium 1210, having stored thereon the computer program 1209, may comprise instructions which, when executed on at least one processor 1205, cause the at least one processor 1205 to carry out the actions described herein, as performed by the second node 112. In some embodiments, the computer-readable storage medium 1210 may be a non-transitory computer-readable storage medium, such as a CD ROM disc, or a memory stick. In other embodiments, the computer program 1209 product may be stored on a carrier containing the computer program 1209 just described, wherein the carrier is one of an electronic signal, optical signal, radio signal, or the computer-readable storage medium 1210, as described above.

The second node 112 may comprise a communication interface configured to facilitate, or an interface unit to facilitate, communications between the second node 112 and other nodes or devices, e.g., the first node 111, the third node 113, the another node 114, and/or, any other nodes in the first plurality of nodes 110, any of the devices in the plurality of client computing devices 120, any node in the cloud 115, and/or or another structure in the communications system 100. The interface may, for example, include a transceiver configured to transmit and receive radio signals over an air interface in accordance with a suitable standard.

In other embodiments, the second node 112 may comprise the following arrangement depicted in FIG. 12b. The second node 112 may comprise a processing circuitry 1205, e.g., one or more processors such as the processor 1205, in the second node 112 and the memory 1206. The second node 112 may also comprise a radio circuitry 1211, which may comprise e.g., the receiving port 1207 and the sending port 1208. The processing circuitry 1205 may be configured to, or operable to, perform the method actions according to FIG. 4, and/or FIG. 6-FIG. 8, in a similar manner as that described in relation to FIG. 12a. The radio circuitry 1211 may be configured to set up and maintain at least a wireless connection with the first node 111, the third node 113, the another node 114, and/or, any other nodes in the first plurality of nodes 110, any of the devices in the plurality of client computing devices 120, any node in the cloud 115, and/or or another structure in the communications system 100. Circuitry may be understood herein as a hardware component.

Hence, embodiments herein also relate to the second node 112 operative to operate in the communications system 100. The second node 112 may comprise the processing circuitry 1205 and the memory 1206, said memory 1206 containing instructions executable by said processing circuitry 1205, whereby the second node 112 is further operative to perform the actions described herein in relation to the second node 112, e.g., in FIG. 4, and/or FIG. 6-FIG. 8.

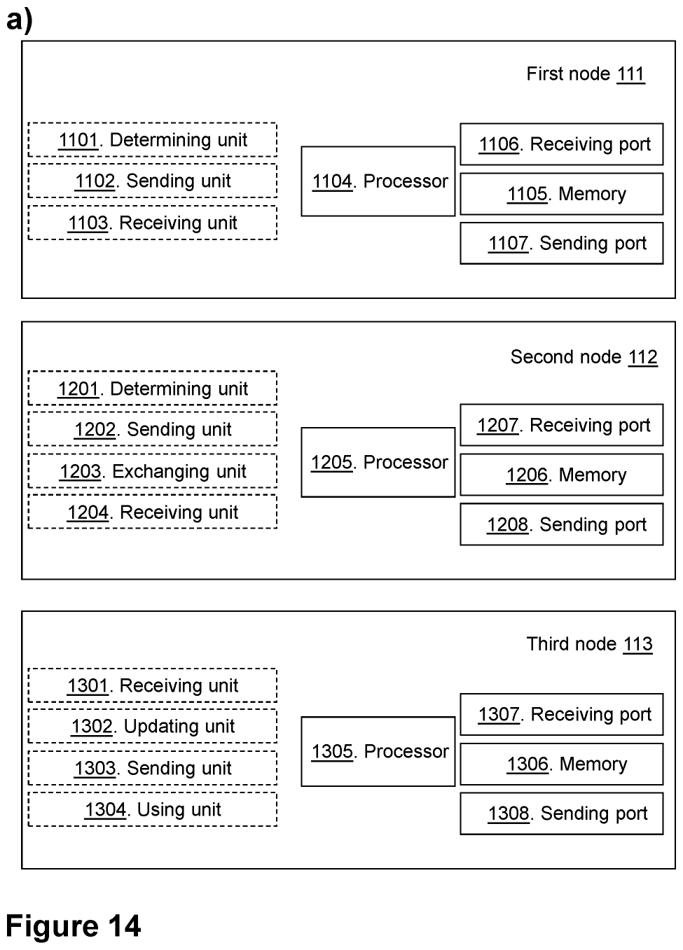

FIG. 13 depicts two different examples in panels a) and b), respectively, of the arrangement that the third node 113, may comprise. In some embodiments, the third node 113 may comprise the following arrangement depicted in FIG. 13a. The third node 113 is configured to be comprised in the first set of nodes 121 of the first plurality of nodes 110 configured to operate in the communications system 100. The third node 113 is for handling the prediction of the event.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. In FIG. 13, optional units are indicated with dashed boxes.

The detailed description of some of the following corresponds to the same references provided above, in relation to the actions described for the third node 113, and will thus not be repeated here. For example, in some examples, each of the nodes of the first plurality of nodes 110 may be Fog nodes.

The third node 113 is also configured to perform the receiving of Action 502, e.g., by means of a receiving unit 1301 within the third node 113, configured to, receive the respective fourth indication from the other nodes in the first set of nodes 121. The respective fourth indication is configured to indicate the respective prediction on the event. The third node 113 is configured to be forbidden from accessing the respective set of observations collected by the other nodes in the first set of nodes 121 on the event. The third node 113 is a leader node of the first set of nodes 121.

The third node 113 is configured to perform the updating of Action 503, e.g., by means of an updating unit 1302 configured to, update the machine-learning model of the event based on the respective fourth indications configured to be received, and the own prediction of the third node 113 on the event based on the respective set of observations configured to be collected by the third node 113 on the event.

The third node 113 is also configured to perform the sending of Action 504, e.g. by means of a sending unit 1303 within the third node 113, configured to, send the fifth indication configured to indicate the machine-learning model configured to be updated to another node 114 in the communications system 100. At least one of the following applies: i) the another node 114 is configured to be the leader node of the second set of nodes 122 configured to be comprised in the first plurality of nodes 110, and all nodes in the first plurality of nodes 110 are configured to belong to the same layer 151 of nodes in the communications system 100, and ii) the communications system 100 is configured to comprise multiple pluralities of nodes 140 hierarchically organized in the plurality of layers 150. The another node 114 is configured to be in a different layer 153 of the of the plurality of layers 150 than the layer 151 wherein the third node 113 is configured to be comprised.

The third node 113 may be configured to perform the receiving of Action 501, e.g., by means of the receiving unit 1301 within the third node 113, configured to, receive the third indication from the second node 112 configured to be comprised in the first set of nodes 121. The third indication is configured to indicate that the third node 113 is the leader of the first set of nodes 121.

In some embodiments, a) the communications system 100 may be configured to comprise multiple pluralities of nodes 140 hierarchically organized in the plurality of layers 150, and b) all nodes in the first plurality of nodes 110 may be configured to belong to the same layer 151 of the plurality of layers 150.

In some embodiments, a) the communications system 100 may be configured to comprise multiple pluralities of nodes 140 hierarchically organized in the plurality of layers 150, b) all nodes in the first set of nodes 121 other than the third node 113 may be configured to belong to the same layer 151 of the plurality of layers 150, and c) the first set of nodes 121 may be configured to comprise the plurality of second sets of nodes 132 of the first plurality of nodes 110 configured to operate in a communications system 100. Each of the other nodes in the first set of nodes 121 may be configured to be a respective leader of a respective second set of nodes 132 in the plurality of second sets of nodes 132.

In some embodiments, to update may be configured to be based on minimizing a cross-entropy between the respective fourth indications configured to be received, and the outcome of the machine-learning model configured to be updated.

The embodiments herein in the third node 113 may be implemented through one or more processors, such as a processor 1305 in the third node 113 depicted in FIG. 13a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the third node 113. One such carrier may be in the form of a CD ROM disc. It is however feasible with other data carriers such as a memory stick. The computer program code may furthermore be provided as pure program code on a server and downloaded to the third node 113.

The third node 113 may further comprise a memory 1306 comprising one or more memory units. The memory 1306 is arranged to be used to store obtained information, store data, configurations, schedulings, and applications etc. to perform the methods herein when being executed in the third node 113.

In some embodiments, the third node 113 may receive information from, e.g., the first node 111, the second node 112, the another node 114, and/or, any other nodes in the first plurality of nodes 110, any of the devices in the plurality of client computing devices 130 and/or any node in the cloud 115, through a receiving port 1307. In some embodiments, the receiving port 1307 may be, for example, connected to one or more antennas in third node 113. In other embodiments, the third node 113 may receive information from another structure in the communications system 100 through the receiving port 1307. Since the receiving port 1307 may be in communication with the processor 1305, the receiving port 1307 may then send the received information to the processor 1305. The receiving port 1307 may also be configured to receive other information.

The processor 1305 in the third node 113 may be further configured to transmit or send information to e.g., the first node 111, the second node 112, the another node 114, and/or, any other nodes in the first plurality of nodes 110, any of the devices in the plurality of client computing devices 130, any node in the cloud 115, and/or or another structure in the communications system 100, through a sending port 1308, which may be in communication with the processor 1305, and the memory 1306.

Those skilled in the art will also appreciate that the units 1301-1304 described above may refer to a combination of analog and digital circuits, and/or one or more processors configured with software and/or firmware, e.g., stored in memory, that, when executed by the one or more processors such as the processor 1305, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1301-1304 described above may be implemented as one or more applications running on one or more processors such as the processor 1305.

Thus, the methods according to the embodiments described herein for the third node 113 may be respectively implemented by means of a computer program 1309 product, comprising instructions, i.e., software code portions, which, when executed on at least one processor 1305, cause the at least one processor 1305 to carry out the actions described herein, as performed by the third node 113. The computer program 1309 product may be stored on a computer-readable storage medium 1310. The computer-readable storage medium 1310, having stored thereon the computer program 1309, may comprise instructions which, when executed on at least one processor 1305, cause the at least one processor 1305 to carry out the actions described herein, as performed by the third node 113. In some embodiments, the computer-readable storage medium 1210 may be a non-transitory computer-readable storage medium, such as a CD ROM disc, or a memory stick. In other embodiments, the computer program 1309 product may be stored on a carrier containing the computer program 1309 just described, wherein the carrier is one of an electronic signal, optical signal, radio signal, or the computer-readable storage medium 1210, as described above.

The third node 113 may comprise a communication interface configured to facilitate, or an interface unit to facilitate, communications between the third node 113 and other nodes or devices, e.g., the first node 111, the second node 112, the another node 114, and/or, any other nodes in the first plurality of nodes 110, any of the devices in the plurality of client computing devices 130, any node in the cloud 115, and/or or another structure in the communications system 100. The interface may, for example, include a transceiver configured to transmit and receive radio signals over an air interface in accordance with a suitable standard.

In other embodiments, the third node 113 may comprise the following arrangement depicted in FIG. 13b. The third node 113 may comprise a processing circuitry 1305, e.g., one or more processors such as the processor 1305, in the third node 113 and the memory 1306. The third node 113 may also comprise a radio circuitry 1311, which may comprise e.g., the receiving port 1307 and the sending port 1308. The processing circuitry 1305 may be configured to, or operable to, perform the method actions according to FIG. 5, and/or FIG. 6-FIG. 8, in a similar manner as that described in relation to FIG. 13a. The radio circuitry 1211 may be configured to set up and maintain at least a wireless connection with the first node 111, the second node 112, the another node 114, and/or, any other nodes in the first plurality of nodes 110, any of the devices in the plurality of client computing devices 130, any node in the cloud 115, and/or or another structure in the communications system 100. Circuitry may be understood herein as a hardware component.

Hence, embodiments herein also relate to the third node 113 operative to operate in the communications system 100. The third node 113 may comprise the processing circuitry 1305 and the memory 1306, said memory 1306 containing instructions executable by said processing circuitry 1305, whereby the third node 113 is further operative to perform the actions described herein in relation to the third node 113, e.g., in FIG. 5, and/or FIG. 6-FIG. 8.

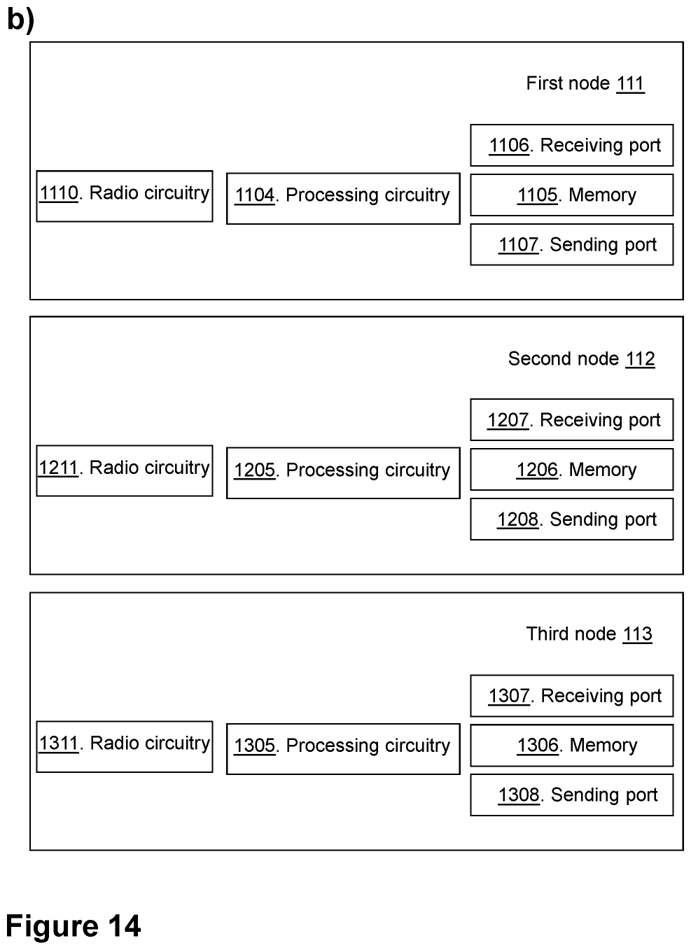

FIG. 14 depicts two different examples in panels a) and b), respectively, of the arrangement that the communications system 100 may comprise. The communications system 100 comprises the first node 111, the second node 112 and the third node 113. The communications system 100 is for handling the prediction of the event. The communications system 100 is configured to comprise the first plurality of nodes 110.

The configurations described for the first node 111, the second node 112, and the third node 113 in relation to FIG. 14 may be understood to correspond to those described in FIG. 11, FIG. 12 and FIG. 13, respectively, and to be performed, e.g., by means of the corresponding units and arrangements described in FIG. 11, FIG. 12 and FIG. 13, which will not be repeated here in its entirety. Only some of the features are described here.

The communications system 100 is further configured to, e.g., by means of the determining unit 1101 within the first node 111, configured to, determine, by the first node 111, the first set of nodes 121 in the first plurality of nodes 110. The determining is configured to be based on: i) the first pattern of arrival of service requests received over the first period of time by the first plurality of nodes 110 from the plurality of client computing devices 120 of the first plurality of nodes 110, ii) the second pattern in the variance of data configured to be collected for the service requests of the different type configured to be received over the second period of time by the second plurality of nodes 119 in the communications system 100, iii) the first measure of similarity in the distribution pattern of data configured to be collected by the nodes in the first plurality of nodes 110 over the first period of time, about the service requests configured to be received of the same type, and iv) the second measure of entropy of the data configured to be collected by the nodes in the first plurality of nodes 110 over the first period of time, about the service requests configured to be received.

The communications system 100 is further configured, e.g., by means of the sending unit 1102 within the second node 112, configured to, send, by the first node 111, the first indication to the nodes comprised in the determined set of nodes 121. The first indication is configured to indicate their belonging to the first set of nodes 110.

The communications system 100 is further configured to, e.g., by means of the determining unit 1201 within the second node 112, configured to, determine, by the second node 112, the second node 112 being configured to be comprised in the first set of nodes 121, the vote for one of the nodes configured to be comprised in the first set of nodes 121 to be candidate for leader node 113 of the first set of nodes 121 in the handling of the prediction of the event. The vote is configured to be based on at least one of the following with respect to the candidate: i) the available energy resources, ii) the average uptime, iii) the available computing power, iv) the computing latency, v) the communication constraint, the communication constraint being configured to be based on the energy cost and the number of connections of the candidate with the other nodes in the first set of nodes 121, and vi) the probability of state change of the candidate.

The communications system 100 is further configured to, e.g., by means of the sending unit 1202 within the first node 111, configured to, send, by the second node 112 the second indication to the nodes in the first set of nodes 121. The second indication is further configured to indicate the vote configured to be determined.

The communications system 100 is further configured to, e.g., by means of the exchanging unit 1203 within the second node 112, configured to, exchange, by the second node 112 the third indication with the nodes in the first set of nodes 121. The third indication is configured to indicate that the third node 113 is the leader node 113 for the first set of nodes 121. The exchanging of the third indication is configured to be based on the second indication configured to be sent.

The communications system 100 is further configured to, e.g., by means of the receiving unit 1301 within the third node 113, configured to, receive, by the third node 113, the respective fourth indication from the other nodes in the first set of nodes 121. The respective fourth indication is configured to indicate the respective prediction on the event. The third node 113 is configured to be forbidden from accessing the respective set of observations configured to be collected by the other nodes in the first set of nodes 121 on the event. The third node 113 is the leader node of the first set of nodes 121.

The communications system 100 is further configured to, e.g., by means of the updating unit 1302 within the third node 113, configured to, update, by the third node 113, the machine-learning model of the event based on the respective fourth indications configured to be received, and the own prediction of the third node 113 on the event based on the respective set of observations configured to be collected by the third node 113 on the event.

The communications system 100 is further configured to, e.g., by means of the sending unit 1303 within the third node 113, configured to, send, by the third node 113, the fifth indication configured to indicate the updated machine-learning model to the another node 114 in the communications system 100. At least one of the following applies: i) the another node 114 is configured to be the leader node of a second set of nodes 122 configured to be comprised in the first plurality of nodes 110, and all nodes in the first plurality of nodes 110 are configured to belong to the same layer 151 of nodes in the communications system 100, and ii) the communications system 100 is configured to comprise multiple pluralities of nodes 140 hierarchically organized in the plurality of layers 150. The another node 114 is configured to be in a different layer 152 of the of the plurality of layers 150 than the layer 151 wherein the third node 113 is comprised.

When using the word “comprise” or “comprising”, it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

Ingram, Rebecca, Tsvetomira Radeva, Patrick Shields, Saira Viqar, Jennifer E. Walter, and Jennifer L. Welch. “A leader election algorithm for dynamic networks with causal clocks.” Distributed computing 26, no. 2 (2013): 75-97.
Vasudevan, Sudarshan, Brian DeCleene, Neil Immerman, Jim Kurose, and Don Towsley. “Leader election algorithms for wireless ad hoc networks.” In Proceedings DARPA Information Survivability Conference and Exposition, vol. 1, pp. 261-272. IEEE, 2003.
Lalitha, Anusha, Osman Cihan Kilinc, Tara Javidi, and Farinaz Koushanfar. “Peer-to-peer Federated Learning on Graphs.” arXiv preprint arXiv:1901.11173 (2019).
Jeong, Eunjeong, Seungeun Oh, Hyesung Kim, Jihong Park, Mehdi Bennis, and Seong-Lyun Kim. “Communication-efficient on-device machine learning: Federated distillation and augmentation under non-iid private data.” arXiv preprint arXiv:1811.11479 (2018).
Sattler, Felix, Klaus-Robert Müller, and Wojciech Samek. “Clustered Federated Learning: Model-Agnostic Distributed Multi-Task Optimization under Privacy Constraints.” arXiv preprint arXiv:1910.01991 (2019).
OpenFog Reference Architecture for Fog Computing Produced by the OpenFog Consortium Architecture Working Group, February 2017 https://patentscope.wipo.int/search/en/detail.jsf?docId=WO2019123471.

1-36. (canceled)

37. A method performed by a first node operating in a communications system comprising a first plurality of nodes, the method comprising:
determining a first set, of the first plurality of nodes, for handling of a prediction of an event in the communication network, wherein the determining is based on the following:
a first pattern of arrival of service requests received over a first period of time by the first plurality of nodes from a plurality of computing device clients,
a second pattern in a variance of data collected for the service requests of a different type received over a second period of time by a second plurality of nodes in the communications system,
a first measure of similarity in a distribution pattern of data collected by the nodes of the first plurality over the first period of time, about the service requests received of a same type, and
a second measure of entropy of the data collected by the nodes in the first plurality of nodes over the first period of time, about the service requests received, and
sending a first indication to the nodes of the determined first set, wherein the first indication indicates that the respective nodes belong to the first set for handling of a prediction of an event in the communication network.

38. The method according to claim 37, wherein determining the first set of nodes is performed by analyzing data from every two nodes in the first plurality of nodes at a time.

39. The method according to claim 37, wherein determining the first set of nodes is further based on at least one of the following:
a maximum number of nodes allowed to belong to the first set of nodes, and
a geographical location the nodes in the first plurality of nodes have to have to be eligible to belong to the first set of nodes.

40. The method according to claim 37, wherein determining the first set of nodes comprises determining respective weights for the first pattern, the second pattern, the first measure, and the second measure.

41. The method according to claim 40, wherein determining the first set of nodes further comprises creating an adjacency matrix (M) from a network graph that is based on the determined respective weights.

42. The method according to claim 41, wherein determining the first set of nodes further comprises performing an agglomerative hierarchical clustering by considering a respective distance between the respective weights in the adjacency matrix (M).

43. The method according to claim 37, further comprising receiving, from the first plurality of nodes, respective first information regarding:
the arrival of the service requests received over the first period of time,
the data collected for the service requests received by the second plurality of nodes, and
the data collected by the first plurality of nodes over the first period of time, about the service requests received.

44. The method according to claim 42, further comprising receiving, from a further node of the communications system, second information regarding the service requests received over the second period of time.

45. The method according to claim 37, wherein:
the communications system comprises multiple pluralities of nodes hierarchically organized in a plurality of node layers; and
determining the first set of nodes is based on a restriction that all node of the first plurality must belong to a same node layer.

46. A method performed by a second node of a first set of nodes of a first plurality of nodes operating in a communications system, the method comprising:
determining a vote for one of the first set of nodes to be candidate for leader node, of the first set, for handling of a prediction of an event in the communication system, wherein determining the vote is based on at least one of the following with respect to the candidate:
available energy resources,
average uptime,
available computing power,
computing latency,
a communication constraint, the communication constraint being based on an energy cost and a number of connections of the candidate with the other nodes in the first set of nodes, and
a probability of state change of the candidate; and,
sending, to the nodes of the first set, a second indication of the determined vote; and
sending, to the nodes of the first set, a third indication indicating that a third node is the leader node of the first set, wherein the third indication is based on the second indication sent to the nodes of the first set.

47. The method according to claim 46, further comprising receiving, from a first node of the communications system, a first indication indicating that the second node is part of the first set of nodes, wherein the determining the vote is responsive to the first indication.

48. The method according to claim 46, further comprising:
receiving, from all other nodes of the first set, respective votes for one of the first set of nodes to be candidate for leader node, of the first set, for handling of a prediction of an event in the communication network; and
based on the received votes, determining the third node to be the leader node for the first set of nodes.

49. A method performed by a third node of a first set of nodes of a first plurality of nodes operating in a communications system, the method comprising:
receiving, from all other nodes of the first set of nodes, respective fourth indications indicating respective predictions of an event in the communication system, wherein:
the third node is forbidden from accessing respective sets of observations on the event that were collected by the other nodes in the first set of nodes, and
the third node is a leader node of the first set of nodes;
updating a machine-learning model of the event based on the following:
the respective fourth indications received from the other nodes of the first set, and
a prediction of the event by the third node, based on a set of observations on the event that were collected by the third node; and
sending a fifth indication indicating the updated machine-learning model to a further node in the communications system, wherein at least one of the following conditions applies:
(i) the communications system comprises multiple pluralities of nodes hierarchically organized in a plurality of node layers;
(ii) the further node is part of a different node layer than the third node;
(iii) the further node is a leader node of a second set of nodes of the first plurality; and
(iv) all nodes of the first plurality are part of a same node layer.

50. The method according to claim 49, further comprising receiving, from a second node of the first set, a third indication indicating that the third node is leader node, of the first set, for handling of a prediction of an event in the communication network.

51. The method according to claim 49, wherein conditions (i) and (iv) apply.

52. The method according to any claim 49, wherein:
condition (i) applies;
all nodes of the first set, other than the third node, belong to a same node layer;
the first plurality of nodes comprises a plurality of second sets of nodes; and
each node of the first set is a leader of a corresponding second set of nodes.

53. The method according to claim 49, wherein updating the machine-learning model of the event is based on minimizing a cross-entropy between the received respective fourth indications and an outcome of the updated machine-learning model.

54. A first node configured to operate in a communications system comprising a first plurality of nodes, the first node comprising:
communication interface circuitry configured to communicate with other nodes of the communication system; and
processing circuitry operably coupled to the communication interface circuitry, whereby the processing circuitry and the communication interface circuitry are configured to perform operations corresponding to the method of claim 37.

55. A second node configured to operate as one of a first set of nodes of a first plurality of nodes in a communications system, the second node comprising:
communication interface circuitry configured to communicate with other nodes of the communication system; and
processing circuitry operably coupled to the communication interface circuitry, whereby the processing circuitry and the communication interface circuitry are configured to perform operations corresponding to the method of claim 46.

56. A third node configured to operate as one of a first set of nodes of a first plurality of nodes in a communications system, the third node comprising:
communication interface circuitry configured to communicate with other nodes of the communication system; and
processing circuitry operably coupled to the communication interface circuitry, whereby the processing circuitry and the communication interface circuitry are configured to perform operations corresponding to the method of claim 49.
